(19) United States
(12) Patent Application Publication
(10) Pub. No.: US 2018/0245780 A1
(43) Pub. Date: Aug. 30, 2018

(54) LIGHTING FIXTURE

(71) Applicant: Panasonic Intellectual Property Management Co., Ltd., Osaka (JP)

(72) Inventors: Toshizumi OKADA, Osaka (JP); Satoru SAKURAI, Osaka (JP); Naoki KOMATSU, Hyogo (JP); Koji MATSUSHITA, Osaka (JP); Ryousuke IJICHI, Osaka (JP); Yuzuru TANAKA, Osaka (JP)

(73) Assignee: PANASONIC INTELLECTUAL PROPERTY MANAGEMENT CO., LT D., Osaka (JP)

(21) Appl. No.: 15/888,428

(22) Filed: Feb. 5, 2018

(30) Foreign Application Priority Data
Feb. 24, 2017 (JP) 2017-033903
Feb. 24, 2017 (JP) 2017-033915

(51) Int. Cl. F21V 21/04; F21S 8/02; F21S 8/04; H05B 37/02; G08C 23/04

(52) U.S. Cl. CPC F21V 21/041; F21S 8/02; F21V 7/10; H05B 37/0272; G08C 23/04; F21S 8/04

(57) ABSTRACT

A lighting fixture includes: a lamp that is configured to be recessed in an opening of a ceiling, and includes a light source that emits illumination light; and a power supply that is configured to be disposed behind the ceiling when the lighting fixture is in the opening of the ceiling, and generates power for causing the light source to emit the illumination light. The lamp includes an infrared communication receiver that receives an infrared signal for controlling the lighting fixture. The power supply includes a radio communication circuit that receives a radio signal for controlling the lighting fixture.

### CROSS REFERENCE TO RELATED APPLICATION

This application claims the benefit of priority of Japanese Patent Application Number 2017-033903 filed on Feb. 24, 2017 and Japanese Patent Application Number 2017-033915 filed on Feb. 24, 2017, the entire content of which are hereby incorporated by reference.

### BACKGROUND

### 1. Technical Field

The present disclosure relates to a recessed ceiling lighting fixture.

### 2. Description of the Related Art

A lighting fixture that is installed on a ceiling surface, such as a non-recessed ceiling light, is conventionally known (for example, see Japanese Unexamined Patent Application Publication No. 2012-146666). For example, the non-recessed ceiling light includes a light source module that emits illumination light, a fixture main body to which the light source module is attached, a power supply housed in the fixture main body, and a light-transmissive globe attached to the fixture main body so as to cover the light source module.

A recessed ceiling lighting fixture that is installed recessed in a ceiling, such as a downlight, is also known (for example, see Japanese Unexamined Patent Application Publication No. 2008-311238). The recessed ceiling lighting fixture includes a lamp configured to attach to a ceiling while in an opening of the ceiling, and a power supply that is disposed behind the ceiling. The lamp includes, for example, a fixture main body to which a light source module is attached, and a frame for holding the fixture main body in the opening of the ceiling.

In the lighting fixture, the light source module is configured of, for example, light emitting diodes (LEDs). In such a case, the power supply generates power for causing the light source module to emit light by, for example, converting AC power from a utility power source into DC power. The power generated by the power supply is supplied to the light source module via a wire.

### SUMMARY

In recent years, lighting fixtures, such as non-recessed ceiling lights, having a radio communication function have been proposed. In non-recessed ceiling lights having a radio communication function, a radio antenna and radio communication circuit for performing radio communication are included in the power supply stored in the fixture main body, and the lighting fixture is controlled upon receipt of a radio signal by the radio antenna. For example, a user can operate a radio remote control to pair the radio remote control with the lighting fixture as well as to create a group including a plurality of lighting fixtures.

Lighting fixtures, such as non-recessed ceiling lights, having an infrared communication function are also known. Lighting fixtures having an infrared communication function include an infrared communication receiver which includes an infrared receiver, and the lighting fixture is controlled upon receipt of an infrared signal by the infrared receiver. For example, a user can operate an infrared remote control to turn on or off the lighting fixture, adjust the dimming of the lighting fixture, and adjust the color of the light emitted by the lighting fixture.

However, unlike with a non-recessed ceiling light it is not possible to perform both radio communication and infrared communication with a recessed ceiling lighting fixture, such as a downlight, due to the power supply being disposed behind the ceiling.

The present disclosure has been conceived to overcome the above problem, and has an object to provide a recessed ceiling lighting fixture capable of performing both radio communication and infrared communication.

In order to achieve this object, a lighting fixture according to one aspect of the present invention includes: a lamp configured to be recessed in an opening of a ceiling, and includes a light source that emits illumination light; and a power supply that is configured to be disposed behind the ceiling when the lighting fixture is in the opening of the ceiling, and to generate power for causing the light source to emit the illumination light. The lamp includes an infrared communication receiver that receives an infrared signal for controlling the lighting fixture. The power supply includes a radio communication circuit that receives a radio signal for controlling the lighting fixture.

According to the present disclosure, it is possible to realize a recessed ceiling lighting fixture that can perform both radio communication and infrared communication.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is a cross sectional view schematically illustrating a lighting fixture according to Embodiment 1, which is installed recessed in a coiling;

FIG. 2 is a perspective view of a lamp included in the lighting fixture according to Embodiment 1;

FIG. 3 is a perspective view of the lamp included in the lighting fixture according to Embodiment 1;

FIG. 4 is a cross sectional view of the lamp included in the lighting fixture according to Embodiment 1;

FIG. 5 is an exploded view of an infrared communication receiver included in the lighting fixture according to Embodiment 1;

FIG. 6 is a cross sectional view of a lamp included in a lighting fixture according to Variation 1 of Embodiment 1;

FIG. 7 is a cross sectional view of a lamp included in a lighting fixture according to Variation 2 of Embodiment 1;

FIG. 8 is a perspective view of a lamp included in a lighting fixture according to Embodiment 2;

FIG. 9 is a perspective view of the lamp included in the lighting fixture according to Embodiment 2;

FIG. 10 is an enlarged view of the lamp included in the lighting fixture according to Embodiment 2;

FIG. 11 is an enlarged view of the lamp included in the lighting fixture according to a variation of Embodiment 2;

FIG. 12 is a cross sectional view schematically illustrating a lighting fixture according to Embodiment 3, which is installed recessed in a ceiling;

FIG. 13 is a perspective view of the lamp included in the lighting fixture according to Embodiment 3;

FIG. 14 is a perspective view of the lamp included in the lighting fixture according to Embodiment 3;

FIG. 15 is a cross sectional view of the lamp included in the lighting fixture according to Embodiment 3;

FIG. 16 is for illustrating the rotational movement of the lamp included in the lighting fixture according to Embodiment 3;

FIG. 17 is a cross sectional view of a lamp included in a lighting fixture according to Variation 1 of Embodiment 3;

FIG. 18 is a cross sectional view of a lamp included in a lighting fixture according to Variation 2 of Embodiment 3; and

FIG. 19 is a cross sectional view of a lamp included in a lighting fixture according to Variation 3 of Embodiment 3.

### DETAILED DESCRIPTION OF THE EMBODIMENTS

The following describes exemplary embodiments of the present disclosure with reference to the drawings. Each of the embodiments described below is merely one specific example of the present disclosure. The numerical values, shapes, materials, elements, arrangement and connection of the elements, etc., indicated in the following embodiments are given merely by way of illustration and are not intended to limit the present disclosure. Therefore, among elements in the following embodiments, those not recited in any one of the independent claims defining the broadest inventive concept of the present disclosure are described as optional elements.

Note that the figures are schematic illustrations and are not necessarily precise depictions. Moreover, in the figures, elements that are essentially the same share like reference signs. Accordingly, duplicate description is omitted or simplified.

In the written description and drawings, the X, Y, and Z axes indicate the three axes in a three-dimensional orthogonal coordinate system, and in this embodiment, directions parallel to the Z axis extend in vertical directions, and directions perpendicular to the Z axis (i.e., directions parallel to the XY plane) extend in horizontal directions. The X and Y axes are orthogonal to one another and the Z axis.

### Embodiment 1

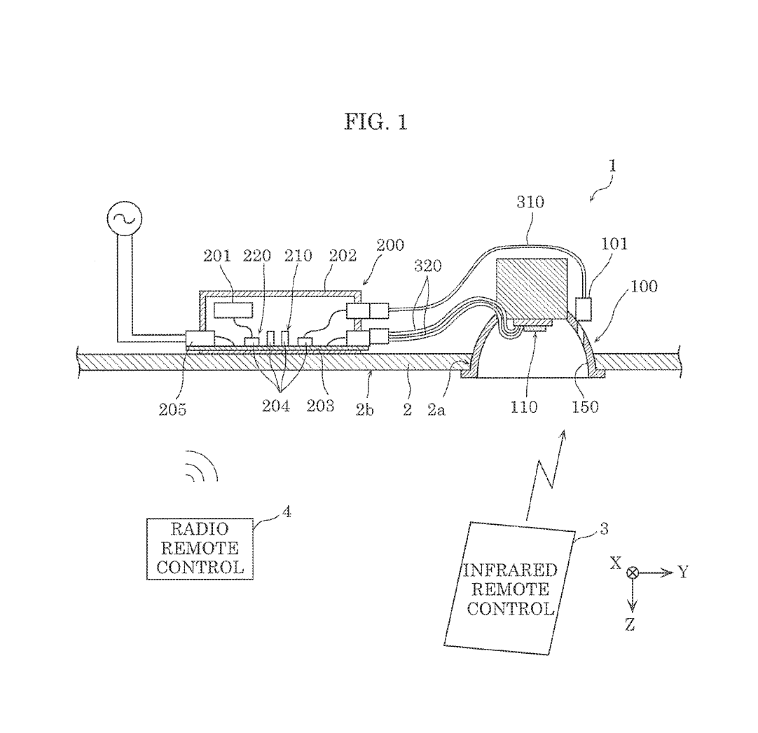

First, an outline of the configuration of lighting fixture 1 according to Embodiment 1 will be given with reference to FIG. 1. FIG. 1 is a cross sectional view schematically illustrating lighting fixture 1 according to Embodiment 1, which is installed recessed in ceiling 2.

As illustrated in FIG. 1, lighting fixture 1 is a recessed ceiling lighting fixture, such as a downlight, and emits illumination light in a downward direction (toward, for example, the floor) as a result of being installed recessed in ceiling 2 of a building.

Lighting fixture 1 includes: lamp 100 including light source 110; and power supply 200 including power supply circuit 210. In this embodiment, lamp 100 and power supply 200 are structurally separate units, and are installed in different locations in or on ceiling 2.

More specifically, lamp 100 is installed recessed in opening 2a of ceiling 2, and power supply 200 is installed disposed on the rear surface of (i.e., behind) ceiling 2. Opening 2a in ceiling 2 defines an attachment hole for attaching lamp 100 to ceiling 2. Opening 2a defines a through-hole that penetrates the ceiling 2, and defines, for example, a circular hole having a circular opening.

Lamp 100 is a lamp body that includes light source 110, and emits illumination light. Lamp 100 also includes infrared communication receiver 101 that receives an infrared signal (infrared light). Infrared communication receiver 101 receives an infrared signal for controlling lighting fixture 1. In one example, the infrared signal has a wavelength of 945 nm, but the infrared signal is not limited to this example. The infrared signal is transmitted from infrared remote control 3 which has an infrared transmission function. In other words, lamp 100 and infrared remote control 3 both have an infrared communication function.

Infrared remote control 3, which performs infrared communication with infrared communication receiver 101, is operated by a user. An infrared signal for controlling lighting fixture 1 is transmitted from infrared remote control 3 in response to the user operating infrared remote control 3.

In this embodiment, for example, an infrared signal (individual lighting control infrared signal) for controlling a lighting aspect of the illumination light emitted by lamp 100 (light source 110) is transmitted from infrared remote control 3. In such a case, infrared communication receiver 101 of lighting fixture 1 receives, as an infrared signal for controlling lighting fixture 1, an infrared signal (individual lighting control infrared signal) for controlling a lighting aspect of the illumination light from light source 110.

More specifically, the user can turn on or off lighting fixture 1, adjust the dimming of lighting fixture 1, and adjust the color of illumination light emitted by lighting fixture 1 by transmitting a lighting control infrared signal to lighting fixture 1 by operating infrared remote control 3. In other words, the user operates infrared remote control 3 when the user wants to individually control a single lighting fixture 1. With this, an infrared signal for turning on or off lamp 100 (light source 110) or an infrared signal for adjusting the dimming or the color of the illumination light emitted by lamp 100 (light source 110) is transmitted from infrared remote control 3.

Moreover, an infrared signal (pairing infrared signal) for pairing lighting fixture 1 and radio remote control 4 is also transmitted from infrared remote control 3. In such a case, infrared communication receiver 101 of lighting fixture 1 receives, as an infrared signal for controlling lighting fixture 1, an infrared signal (pairing infrared signal) for associating lighting fixture 1 with radio remote control 4.

Infrared communication receiver 101 and power supply 200 are connected via, for example, a signal cable (control wire) such as first wire 310, and infrared signals received by infrared communication receiver 101 are transmitted to power supply 200 via first wire 310 as control signals. In other words, first wire 310 transmits, to power supply 200, a control signal dependent on the infrared signal received by infrared communication receiver 101. First wire 310 is, for example, a control wire such as a signal cable.

Power supply 200 includes radio communication circuit 201 that receives a radio signal. Radio communication circuit 201 receives a radio signal for controlling lighting fixture 1. Radio communication circuit 201 includes a radio antenna that receives the radio signal, and a processing circuit (IC) that processes the radio signal received by the radio antenna. The radio antenna is, for example, a patterned antenna provided on a substrate. The radio signal received by the radio antenna is converted into a predetermined control signal (electrical signal) by the processing circuit, and output to control circuit 220 included in power supply 200. Note that the frequency of the radio signal received by radio communication circuit 201 is on the UHF band, and in one example, is on the 920 MHz band, but the frequency is not limited to this example.

The radio signal received by radio communication circuit 201 is, for example, transmitted from radio remote control (radio remote control) 4, which has a radio transmission function. Radio remote control 4 may be a mobile, handheld terminal, and, alternatively, may be attached to, for example, the wall. Radio remote control 4 is, for example, installed on a wall in a room, and performs various types of control with respect to one or more lighting fixtures 1 installed in the room.

Radio remote control 4, which performs radio communication with radio communication circuit 201, is operated by a user. A radio signal for controlling lighting fixture 1 is transmitted from radio remote control 4 in response to the user operating radio remote control 4.

In this embodiment, a radio signal (pairing radio signal) for pairing radio remote control 4 and lighting fixture 1 is also transmitted from that radio remote control 4. In such a case, radio communication circuit 201 of lighting fixture 1 receives, as a radio signal for controlling lighting fixture 1, a radio signal (pairing radio signal) for associating radio remote control 4 and that lighting fixture 1.

Moreover, a radio signal (collective lighting control radio signal) for simultaneously controlling a plurality of lighting fixtures 1 belonging to a single group including radio remote control 4 and a plurality of lighting fixtures 1 paired with radio remote control 4 is transmitted from radio remote control 4. In such a case, radio communication circuit 201 of lighting fixture 1 receives, as a radio signal for controlling lighting fixture 1, a radio signal (collective lighting control radio signal) for simultaneously controlling a plurality of lighting fixtures 1 paired with radio remote control 4 (i.e., a plurality of lighting fixtures 1 belonging to a single group).

Next, an example of a case in which lighting fixture 1 is controlled using infrared remote control 3 and radio remote control 4 will be given. The example will focus on the method for setting up the pairing in particular.

First, radio remote control 4 is placed into pairing mode by operating radio remote control 4, and a pairing radio signal is transmitted from radio remote control 4 to lighting fixture 1. With this, radio communication circuit 201 of lighting fixture 1 receives the pairing radio signal from radio remote control 4. Here, one or more lighting fixtures 1 may be paired with radio remote control 4. The one or more lighting fixtures 1 that receive the pairing radio signal become candidates for pairing with radio remote control 4.

Next, while the pairing radio signal is being transmitted from radio remote control 4, infrared remote control 3 can be operated so as to transmit a pairing infrared signal to a specific lighting fixture 1 that is to be paired with radio remote control 4. The pairing infrared signal transmitted by infrared remote control 3 is received by infrared communication receiver 101 of lighting fixture 1.

With this, the specific lighting fixture 1 that received the pairing infrared signal is paired with radio remote control 4 that transmits the pairing radio signal. When pairing involves a plurality of lighting fixtures 1, each infrared remote control 3 corresponding to the plurality of lighting fixtures 1 are operated sequentially, whereby pairing infrared signal are transmitted sequentially to the plurality of lighting fixtures 1. This makes it possible to pair the one specific radio remote control 4 and the specific lighting fixtures 1.

Then, a lighting aspect is controlled simultaneously for the one or more specific lighting fixtures 1 paired with the specific radio remote control 4 via a collective lighting control radio signal from the specific radio remote control 4. In other words, when the setup of the pairing is complete, it is possible to simultaneously turn on or off and simultaneously adjust the dimming of the plurality of paired specific lighting fixtures 1 belonging to a single group, simply by operating a single specific radio remote control 4.

Moreover, it is possible to individually control a lighting aspect of each lighting fixture 1 even after pairing of the plurality of lighting fixtures 1 is completed by operating infrared remote control 3 corresponding to the target lighting fixture 1.

Note that in this embodiment, radio communication circuit 201 has only the function of receiving radio signals, but radio communication circuit 201 may have a function of transmitting radio signals as well. In such a case, if radio remote control 4 is capable of receiving radio signals, radio remote control 4 can receive a radio signal transmitted by radio communication circuit 201.

Power supply 200 has a power supply function of generating power for causing light source 110 to emit light. More specifically, via power supply circuit 210, power supply 200 converts AC power originating from a utility power source and supplied from power supply terminal block 205 into DC power.

Power supply 200 and lamp 100 (light source 110) are connected via second wire 320, and the DC power generated by power supply 200 is supplied to light source 110 of lamp 100 via second wire 320. Second wire 320 is, for example, a power supply wire, such as a power cable.

Moreover, in this embodiment, power supply 200 further has a lighting control function of controlling a lighting aspect of lamp 100 (light source 110). More specifically, power supply 200 controls, via control circuit 220, a lighting aspect (an aspect of the emitted light) of light source 110 in accordance with a radio signal received by radio communication circuit 201 or an infrared signal received by infrared communication receiver 101. For example, via control circuit 220, power supply 200 turns on or off lamp 100 (light source 110), and changes the brightness, color, and/or color temperature of the light emitted by lamp 100 (light source 110). In this embodiment, control circuit 220 is included in the same circuit board as power supply circuit 210.

Power supply 200 includes radio communication circuit 201 and housing 202 that houses radio communication circuit 201. Power supply 200 further includes circuit board 203 and a plurality of circuit elements 204.

Housing 202 houses radio communication circuit 201 and circuit board 203 on which a plurality of circuit elements 204 are mounted. For example, housing 202 is a metal case or an electrically insulated resin case. In this embodiment, housing 202 is a metal case. Housing 202 is disposed behind the ceiling.

Circuit board 203 is a printed circuit board on which metal structures are printed in a predetermined pattern. The plurality of circuit elements 204 are mounted on circuit board 203.

The plurality of circuit elements 204 include, for example, power supply circuit elements included in power supply circuit 210 that generates power for causing light source 110 to emit light, and control circuit elements included in control circuit 220 that controls a lighting aspect of light source 110.

The power supply circuit elements included in power supply circuit 210 and the control circuit elements included in control circuit 220 include, for example, capacitive elements (e.g., electrolytic capacitors, ceramic capacitors), resistive elements (e.g., resistors), rectifiers, inductors, transistors, noise filters, diodes, integrated circuit (IC) elements, and/or semiconductor elements (e.g., FETs).

For example, power supply circuit 210 converts AC power supplied from, for example, an external power supply, such as a utility power supply, to DC power of a predetermined level by, for example, rectifying, smoothing, and stepping down the power. Control circuit 220 includes, for example a dimming control circuit and a color adjustment control circuit. The DC power output from power supply circuit 210 is controlled by control circuit 220.

Power supply 200 also includes power supply terminal block 205. A wire such as a VVF cable is connected to power supply terminal block 205, and AC power from a utility power supply is supplied to power supply terminal block 205 via this wire. The AC power supplied to power supply terminal block 205 is supplied to power supply circuit 210.

In lighting fixture 1 configured in such a manner, for example, in response to an infrared signal (light) transmitted from infrared remote control 3 being received by infrared communication receiver 101, in accordance with the instruction in the infrared signal, lamp 100 (light source 110) is turned on or off, or the brightness, color, or color temperature of the light emitted by lamp 100 (light source 110) is changed.

In such a case, in response to an infrared signal being received by infrared communication receiver 101 included in lamp 100, the infrared signal is converted into a predetermined control signal (electrical signal) by infrared communication receiver 101, and transmitted to control circuit 220 of power supply 200 via first wire 310.

Then, a control signal based on the infrared signal transmitted to power supply 200 from infrared communication receiver 101 via first wire 310 is processed by control circuit 220 and power supply circuit 210 into desired DC power, which is supplied to light source 110 of lamp 100 via second wire 320. With this, a lighting aspect of light source 110 changes in accordance with the instruction in the infrared signal.

For example, when the infrared signal received by infrared communication receiver 101 is a signal for turning on lighting fixture 1 or a signal for turning off lighting fixture 1, the supply of DC power from power supply 200 (power supply circuit 210) to light source 110 is started or stopped, respectively. Moreover, when the infrared signal received by infrared communication receiver 101 is a dimming signal (PWM dimming signal or phase control dimming signal) or a color adjustment signal, DC power that has undergone dimming control or color adjustment control is supplied from power supply circuit 210 to light source 110, respectively. With this, light source 110 is dimmed so as to change the brightness of the illumination light, or light source 110 is adjusted so as to change the color or color temperature of the illumination light.

Note that the same applies when a lighting aspect of lighting fixture 1 is changed by operating remote control 4 (i.e., when lighting fixture 1 is turned on, turned off, or the emission light is adjusted).

### (Lamp)

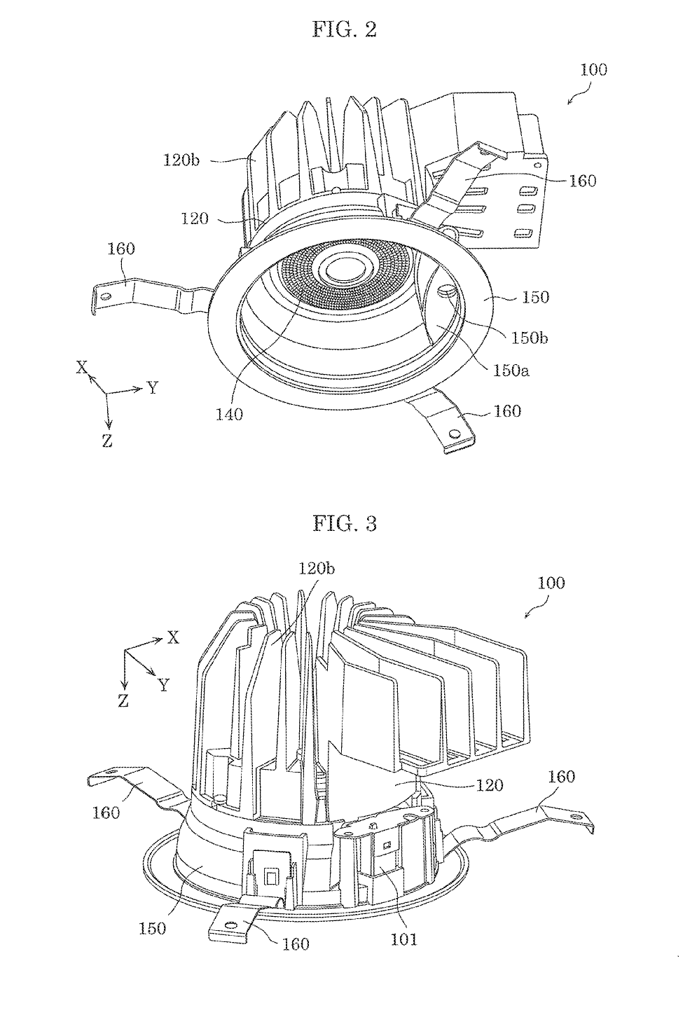

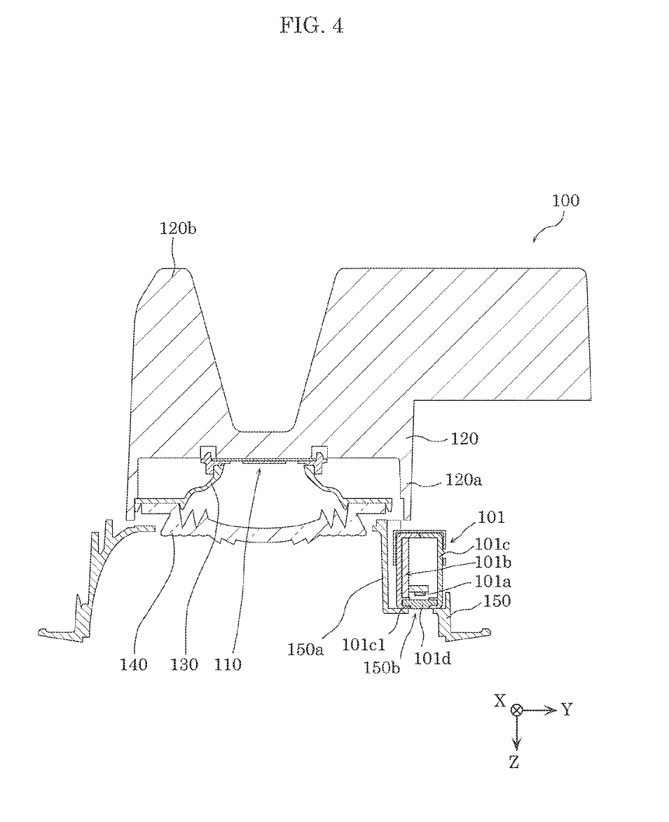

Next, the configuration of lamp 100 in lighting fixture 1 according to Embodiment 1 will be described in detail with reference to FIG. 2 through FIG. 4. FIG. 2 and FIG. 3 are perspective views of lamp 100 in lighting fixture 1 according to Embodiment 1. FIG. 2 is a perspective view from the perspective of the floor, and FIG. 3 is a perspective view from the perspective of an angle opposite the floor. FIG. 4 is a cross sectional view of the same lamp 100. Note that in FIG. 4, only a cross section of lamp 100 is illustrated. Moreover, in FIG. 2 through FIG. 4, illustration of first wire 310 and second wire 320 is omitted.

As illustrated in FIG. 2 through FIG. 4, lamp 100 includes light source 110, pedestal 120, reflector 130, lens 140, and frame 150.

### (Light Source)

Light source 110 illustrated in FIG. 4 is, for example, a light source module that emits white light as the illumination light. In this embodiment, light source 110 is an LED module (LED light source) including LEDs. In one example, light source 110 has a chip on board (COB) structure including a substrate, LEDs mounted on the substrate, and a sealant that seals the LEDs. The LEDs and the sealant collectively function as a light emitter in light source 110.

The substrate is a mounting substrate for mounting the LEDs, and, for example, is a ceramic substrate, a resin substrate, or a metal-based substrate. Note that a pair of electrode terminals for receiving DC power from power supply 200 and metal structures formed in a predetermined pattern for electrically connecting the LEDs may be formed on the substrate. Second wire 320 is connected to the pair of electrode terminals.

The LEDs are one example of light emitting elements, and, for example, are bare chips that emit monochromatic visible light. More specifically, the LEDs are blue LED chips that emit blue light when current passes through. The LEDs are arranged in, for example, a matrix on the substrate. Note that the LEDs need not be provided in plurality; at least one LED is sufficient.

The sealant is, for example, a light-transmissive resin. The sealant according to this embodiment includes phosphor as a wavelength converter that converts the wavelength of light from the LEDs. The sealant is, for example, a phosphor-containing resin such as a silicon resin dispersed with phosphor. When the LEDs are blue LED chips that emit blue light, in order to achieve a white light, YAG yellow phosphor particles, for example, can be used as the phosphor particles. In such a case, the yellow phosphor absorbs part of the blue light emitted by the blue light LED chips which excites and causes the yellow phosphor to emit yellow light. The yellow light then mixes with the blue light unabsorbed by the yellow phosphor, resulting in emission of white light from light source 110.

Note that the sealant is formed in a circular shape so as to collectively seal all of the LEDs, but the sealant may be formed in lines each of which covers a row of the LEDs and, alternatively, may be formed so as to seal each LED individually.

Moreover, light source 110 according to this embodiment is a light source module that can perform dimming control and color adjustment control. Accordingly, light source 110 includes, for example, a plurality of light emitters that emit light of different colors or color temperatures. In such a case, it is possible to change the color and color temperature of each of the light emitters by using LEDs that emit light of different colors and/or adjusting the type and amount of the wavelength converter (phosphor) used.

Light source 110 configured in this way is attached to pedestal 120 via a holder, as illustrated in FIG. 4. For example, light source 110 is disposed in a predetermined position on pedestal 120 by holding down light source 110 on pedestal 120 with the holder and fixing the holder and pedestal 120 together via, for example, a screw. Moreover, in this embodiment, light source 110 is disposed centered about the optical axis of lamp 100.

### (Pedestal)

Pedestal 120 is a fixture main body on which light source 110 is disposed. Pedestal 120 functions to support light source 110 and as a heat sink that disperses heat generated by light source 110. Accordingly, pedestal 120 is desirably made of a material having a high rate of heat transfer, such as a metal such as aluminum or a highly thermally conductive resin. In this embodiment, pedestal 120 is made of die cast aluminum.

As illustrated in FIG. 4, pedestal 120 has a recess including opening 120a. Light source 110 and reflector 130 are disposed inside the recess in pedestal 120. Moreover, lens 140 is disposed in opening 120a of pedestal 120.

Moreover, as illustrated in FIG. 2 through FIG. 4, a plurality of heat dissipating fins 120b are provided on pedestal 120. Each of the plurality of heat dissipating fins 120b has the shape of a flat plate and extends from a rear surface of the pedestal 120, in an area behind the recess of the pedestal 120. Providing heat dissipating fins 120b makes it possible to efficiently dissipate heat generated by light source 110.

### (Reflector)

Reflector 130 illustrated in FIG. 4 is a reflective component that reflects light emitted by light source 110. More specifically, the inner surface of reflector 130 is a reflective surface that reflects light from light source 110. The reflective surface allows reflector 130 to direct the light emitted by light source 110 in a desired direction. In this embodiment, reflector 130 controls the distribution of light such that the light emitted by light source 110 is incident on lens 140. In one example, reflector 130 has the shape of a cylinder whose inner surface is funnel shaped, and whose inner diameter gradually increases from the opening on the side through which light enters (light source side) toward the opening on the side through which light exits.

For example, reflector 130 can be formed from a resin material or metal material. More specifically, reflector 130 may be a white resin-formed piece produced using a resin material such as polybutylene terephthalate (PBT), may be a resin-formed piece including a metal film such as an aluminum film formed on the inner surface, and may be a metal piece formed from a metal material such as aluminum.

Reflector 130 configured in this manner is attached to pedestal 120. More specifically, reflector 130 is indirectly attached to pedestal 120 by being attached to a holder fixed to pedestal 120 for holding light source 110 to pedestal 120.

### (Lens)

As illustrated in FIG. 2 and FIG. 4, lens 140 is arranged so as to cover light source 110. More specifically, lens 140 is attached in the opening of pedestal 120 so as to cover the opening of reflector 130.

Lens 140 transmits light from light source 110 and light reflected by reflector 130. More specifically, lens 140 has a function of controlling, in a predetermined direction, the distribution of light from light source 110 and light reflected by reflector 130. In this embodiment, lens 140 has a Fresnel structure having the function of a Fresnel lens. Lens 140 further has a light diffusing structure. The light diffusing structure is, for example, a plurality of fine protrusions and recesses (dots, prisms) formed on and in the surface of lens 140 through which light exits.

Lens 140 is formed from a light-transmissive material having light transmitting properties. More specifically, lens 140 is made of a transparent resin material such as acrylic or polycarbonate, or a glass material.

### [Frame]

As illustrated in FIG. 1, frame 150 is an attachment component for attaching lamp 100 to ceiling 2 while in opening 2a of ceiling 2. More specifically, frame 150 is attached to ceiling 2 so as to hold pedestal 120 in opening 2a of ceiling 2.

In this embodiment, frame 150 is a cup-shaped frame having a first opening on the vertical lower side and a second opening on the vertical upper side. Frame 150 is made of a metal material such as aluminum. In this embodiment, frame 150 is made of die cast aluminum. Note that the material used for frame 150 is not limited to a metal material, and may be a resin material.

A flange-shaped brim is formed around the first opening on the vertical lower side of frame 150. Lamp 100 is held in opening 2a by abutting the brim of frame 150 to ceiling surface 2b of ceiling 2 and three attachment springs 160 provided on the outer surface of frame 150 pressing against the inner side surface of ceiling 2 defined by opening 2a. Attachment springs 160 are elastic components for attaching lamp 100 to ceiling 2 while in opening 2a of ceiling 2, and have a leaf spring structure. For example, each attachment spring 160 is formed from an elongated metal plate.

Moreover, frame 150 is fixed to pedestal 120 via, for example, a screw or screws. In other words, by attaching frame 150 to ceiling 2, both frame 150 and pedestal 120 are fixed to ceiling 2.

Light that exits lens 140 enters frame 150. Light entering frame 150 passes through frame 150 and exits out of lamp 100. Note that frame 150 may also function as an auxiliary reflector, whereby light incident on the inner surface of frame 150 is reflected by the inner surface of frame 150 and then exits out of frame 150.

Moreover, as illustrated in FIG. 2 and FIG. 4, frame 150 includes recess 150a for disposing infrared communication receiver 101. Recess 150a is formed so as to cause a portion of frame 150 to protrude from the rear side of frame 150 toward the inside of frame 150.

Through-hole 150b through which an infrared signal to be received by infrared communication receiver 101 passes is provided in frame 150. Through-hole 150b is a small diameter hole for infrared signal reception; illumination light from light source 110 does not pass through through-hole 150b.

In this embodiment, through-hole 150b is provided in the bottom surface of recess 150a. In other words, through-hole 150b is provided in location that is not visible to the user. With this, the user can easily perform infrared communication with lighting fixture 1 by pointing the infrared transmitter of infrared remote control 3 toward the vicinity of through-hole 150b.

### (Infrared Communication Receiver)

Infrared communication receiver 101 is provided on lamp 100, and has a function of receiving infrared signals. More specifically, infrared communication receiver 101 converts received infrared signals into predetermined control signals (electrical signals). Infrared communication receiver 101 according to this embodiment is a compact module since it only has the function of infrared communication.

Infrared communication receiver 101 is provided on frame 150. More specifically, infrared communication receiver 101 is disposed on the outer surface of frame 150. In this embodiment, infrared communication receiver 101 is housed in recess 150a formed on the rear side of frame 150. Since this makes it possible to hide infrared communication receiver 101, the user is not aware of the presence of infrared communication receiver 101.

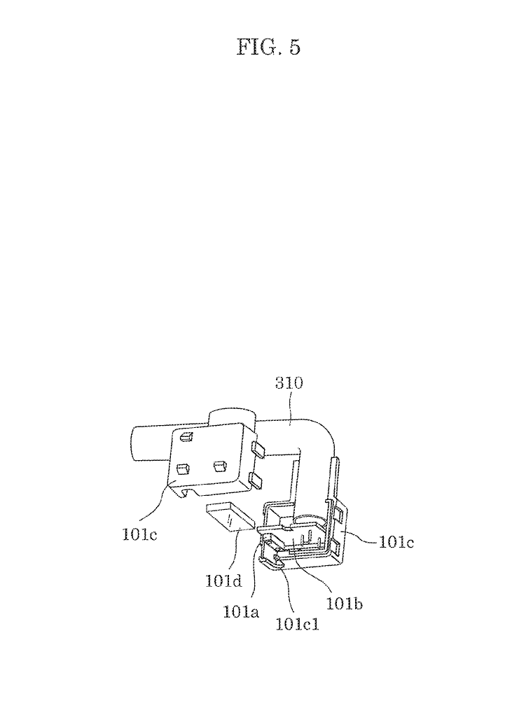

As illustrated in FIG. 4 and FIG. 5, infrared communication receiver 101 includes infrared receiver 101a, circuit board 101b, case 101c, and light-transmissive cover 101d.

Infrared receiver 101a is a receiver that receives infrared signals. More specifically, infrared receiver 101a is an infrared receiver that receives infrared light forming the infrared signal. For example, infrared receiver 101a receives an infrared signal transmitted by infrared remote control 3. Infrared receiver 101a is disposed opposite through-hole 101c1 formed in case 101c.

As well as infrared receiver 101a, a plurality of circuit elements (not illustrated in the drawings) are also mounted on circuit board 101b. The plurality of circuit elements mounted on circuit board 101b form a processing circuit that converts the infrared signal received by infrared receiver 101a into a predetermined control signal (electrical signal). The control signals generated by this processing circuit are transmitted to control circuit 220 of power supply 200 via first wire 310.

Case 101c is a housing that houses infrared receiver 101a and circuit board 101b on which the plurality of circuit elements are mounted. For example, case 101c is made of resin, but this example is not limiting. Case 101c according to this embodiment is divided into two halves, but case 101c may be a single unit.

Through-hole 101c1 for infrared signals to pass through is formed in case 101c. Through-hole 101c1 in infrared communication receiver 101 is located opposite through-hole 150b in frame 150. With this, infrared receiver 101a is disposed opposite through-hole 150b in frame 150 with through-hole 101c1 in case 101c therebetween.

Light-transmissive cover 101d covers through-hole 101c1 formed in case 101c. Light-transmissive cover 101d is formed of a material that transmits the infrared signals. Light-transmissive cover 101d is a rectangular transparent plate, and is formed of, for example, a transparent resin material or glass material. By covering through-hole 101c1 with light-transmissive cover 101d, it is possible to inhibit foreign matter such as dust from entering case 101c through through-hole 101c1. With this, dust, for example, can be inhibited from settling on infrared receiver 101a and preventing infrared receiver 101a from properly receiving the infrared signals.

### (Working Effects)

Next, the working effects of lighting fixture 1 according to this embodiment will be described, along with the developments that led to the present disclosure.

In the past, a lighting fixture that is installed on the surface of a ceiling, such as a non-recessed ceiling light, and has radio communication and infrared communication functions has been proposed. However, unlike with a non-recessed ceiling light, with a recessed ceiling lighting fixture, such as a downlight, it was not possible to perform both radio communication and infrared communication due to the power supply being disposed behind the ceiling.

In particular, the infrared receiver that receives the infrared signals is not able to receive the infrared signals unless it is installed in a location in which the infrared signals are not block by, for example, metal or the ceiling material. If the user does not know where the infrared communication receiver (infrared receiver) is located, the user does not know where to point when transmitting the infrared signals.

With a non-recessed ceiling light, the power supply is located on the room side of the ceiling surface, and the power supply and the lamp (light source) are supported by the fixture main body, and as such, are disposed in the same location. Accordingly, with a non-recessed ceiling light, the radio communication unit (radio antenna, radio processing circuit) and the infrared communication unit (infrared receiver, infrared processing circuit) are integrated in a communication module which is included in the power supply. This makes it possible for the user to perform infrared communication in addition to radio communication by simply transmitting the infrared signals toward the non-recessed ceiling light.

However, a recessed ceiling lighting fixture such as a downlight cannot receive infrared signals if the radio communication unit and infrared communication unit are integrated in a communication module in the power supply since the power supply is disposed behind the ceiling.

Thus, with a recessed ceiling lighting fixture, it is conceivable to provide the integrated communication module of the radio communication unit and the infrared communication unit in the lamp instead of the power supply. However, providing the integrated communication module of the radio communication unit and the infrared communication unit in the lamp increases the size of the lamp, leading to a problem of lack of space for the lamp or the need for a large opening 2a in ceiling 2 to accommodate the lamp.

In this way, unlike with a non-recessed ceiling light, with a recessed ceiling lighting fixture, such as a downlight, it was not possible to perform both radio communication and infrared communication.

In light of this, in lighting fixture 1 according to the present embodiment, radio communication circuit 201 is included in power supply 200 disposed behind the ceiling, and infrared communication receiver 101 is included in lamp 100 installed recessed in opening 2a of ceiling 2, as illustrated in FIG. 1. In other words, infrared communication receiver 101 and radio communication circuit 201 are separated, and infrared communication receiver 101 is included in lamp 100, which is visible to the user.

By including infrared communication receiver 101 in lamp 100 installed recessed in opening 2a of ceiling 2 in this way, the user can easily perform infrared communication with lighting fixture 1.

More specifically, when the user wants to control a lighting aspect of the illumination light emitted by lamp 100 (light source 110), the user can control a lighting aspect of lamp 100 (light source 110) by pointing infrared remote control 3 toward lamp 100 and operating infrared remote control 3 so as to transmit an infrared signal. For example, the user can turn on or off lamp 100 (light source 110) or change the brightness, color, and/or color temperature of the illumination light.

Moreover, since power supply 200 includes radio communication circuit 201, the user can easily perform radio communication with lighting fixture 1. More specifically, when the user wants to change the settings in lighting fixture 1 or wants to control a lighting aspect of the illumination light emitted by lamp 100 (light source 110), the user can change the settings in lighting fixture 1 or control a lighting aspect of lamp 100 (light source 110) by operating radio remote control 4 so as to transmit a radio signal.

Additionally, since radio communication circuit 201 is included in power supply 200 rather than lamp 100, it is possible to inhibit an increase in the size of lamp 100 and it is not necessary to increase the size of opening 2a in ceiling 2.

With lighting fixture 1 according to this embodiment, it is possible to perform both radio communication and infrared communication even when lighting fixture 1 is embodied as a recessed ceiling lighting fixture.

Moreover, with lighting fixture 1 according to this embodiment, since infrared communication receiver 101 and radio communication circuit 201 are disposed separate from each other, compared to a configuration in which the radio communication unit and the infrared communication unit are integrated in a communication module, it is possible to reduce the size of each module. With this, infrared communication receiver 101 and radio communication circuit 201 can be installed without having to increase the diameter of opening 2a of ceiling 2.

In particular, with lighting fixture 1 according to this embodiment, infrared communication receiver 101 is included in lamp 100, which is visible to the user, but infrared communication receiver 101 is a compact module having only an infrared communication function. With this, since infrared communication receiver 101 is included in lamp 100, it is possible to avoid a negative impact on the design aesthetics of lamp 100.

Moreover, lighting fixture 1 according to this embodiment further includes first wire 310 that transmits, to power supply 200, a control signal dependent on the infrared signal received by infrared communication receiver 101.

This makes it possible to control a lighting aspect of the illumination light emitted by lamp 100 (light source 110) by processing, via power supply 200, a control signal dependent on the infrared signal received by infrared communication receiver 101. In other words, an infrared signal received by infrared communication receiver 101 included in lamp 100 installed recessed in opening 2a of ceiling 2 is first transmitted, as a control signal, to power supply 200 disposed behind the ceiling and processed by power supply circuit 210 and control circuit 220, and thereafter transmitted again to lamp 100 (light source 110) to control a lighting aspect of the illumination light. This makes it possible to inhibit an increase in costs since it eliminates a need to mount, for example, another power supply circuit or control circuit in lamp 100.

Moreover, as illustrated in FIG. 4, with lighting fixture 1 according to this embodiment, infrared communication receiver 101 is provided on frame 150 attached to ceiling 2 in opening 2a.

Frame 150 is disposed in a location that is visible to the user. Moreover, behind frame 150 is a space behind the ceiling. Accordingly, by providing infrared communication receiver 101 on frame 150, it is possible to dispose infrared communication receiver 101 in a location in which infrared receiver 101a of infrared communication receiver 101 is visible and in which visibility of case 101c of infrared communication receiver 101 is concealed to the user behind frame 150. With this, by including infrared communication receiver 101, it is possible to avoid a negative impact on design aesthetics and easily perform infrared communication with lighting fixture 1. In other words, the user can easily control a lighting aspect of the illumination light from lamp 100 by pointing infrared remote control 3 toward infrared receiver 101a and transmitting an infrared signal.

Moreover, as illustrated in FIG. 4, in lighting fixture 1 according to this embodiment, through-hole 150b through which an infrared signal to be received by infrared communication receiver 101 passes is formed in frame 150.

This makes it possible to improve the reception sensitivity of the infrared signal by infrared communication receiver 101 and allow the user to easily recognize the location of infrared communication receiver 101 (infrared receiver 101a) via the location of through-hole 150b.

### Variation 1 of Embodiment 1

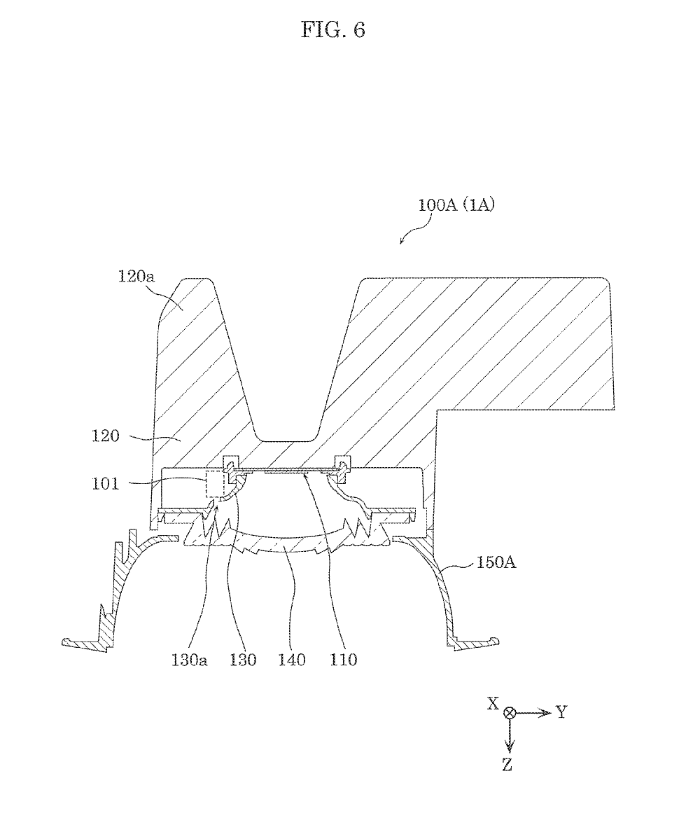

Next, lighting fixture 1A according to Variation 1 of Embodiment 1 will be described with reference to FIG. 6. FIG. 6 is a cross sectional view of lamp 100A included in lighting fixture 1A according to Variation 1 of Embodiment 1. Note that in FIG. 6, only a cross section of lamp 100A is illustrated.

In lighting fixture 1 according to Embodiment 1 described above, infrared communication receiver 101 is provided on frame 150 of lamp 100, but in lighting fixture 1A according to this variation, infrared communication receiver 101 is disposed adjacent to light source 110 of lamp 100A.

More specifically, in this variation, infrared communication receiver 101 is disposed between reflector 130 and pedestal 120. Moreover, through-hole 130a through which an infrared signal to be received by infrared communication receiver 101 passes is formed in reflector 130. Note that similar to Embodiment 1 described above, since lens 140 is made of a transparent resin material or glass material, infrared signals can pass through lens 140. With this, infrared signals can reach infrared receiver 101a (not illustrated in the figure) of infrared communication receiver 101 through lens 140 and through-hole 130a.

Moreover, in this variation, since infrared communication receiver 101 is not provided on frame 150A, unlike frame 150 according to Embodiment 1 described above, frame 150A does not include recess 150a.

Note that in this variation, apart from the location of infrared communication receiver 101 and the shape of frame 150A, the configuration of lighting fixture 1A is the same as lighting fixture 1 according to Embodiment 1 described above, including power supply 200.

Accordingly, with lighting fixture 1A according to this variation, infrared communication receiver 101 is disposed adjacent to light source 110 of lamp 100A.

Since light source 110 is disposed centered about the optical axis of lamp 100, by disposing infrared communication receiver 101 adjacent to light source 110, infrared communication receiver 101 is also disposed adjacent to the optical axis center of lamp 100. This makes it easier for infrared communication receiver 101 to receive infrared signals. In other words, even if the user does not know where infrared communication receiver 101 (infrared receiver) is disposed or even without the user needing to figure out where infrared communication receiver 101 (infrared receiver) is disposed, it is possible for the user to control a lighting aspect of the illumination light from lamp 100A simply by pointing infrared remote control 3 in the general direction of lamp 100A to transmit an infrared signal.

Moreover, with lighting fixture 1A according to this variation, infrared communication receiver 101 is disposed between reflector 130 and pedestal 120.

With this, since case 101c of infrared communication receiver 101 can be concealed, it is possible to avoid a negative impact on the design aesthetics of lamp 100A by infrared communication receiver 101. In other words, with lighting fixture 1A according to this variation, it is possible to achieve an outer appearance having the same design aesthetics as an existing lighting fixture.

### Variation 2 of Embodiment 1

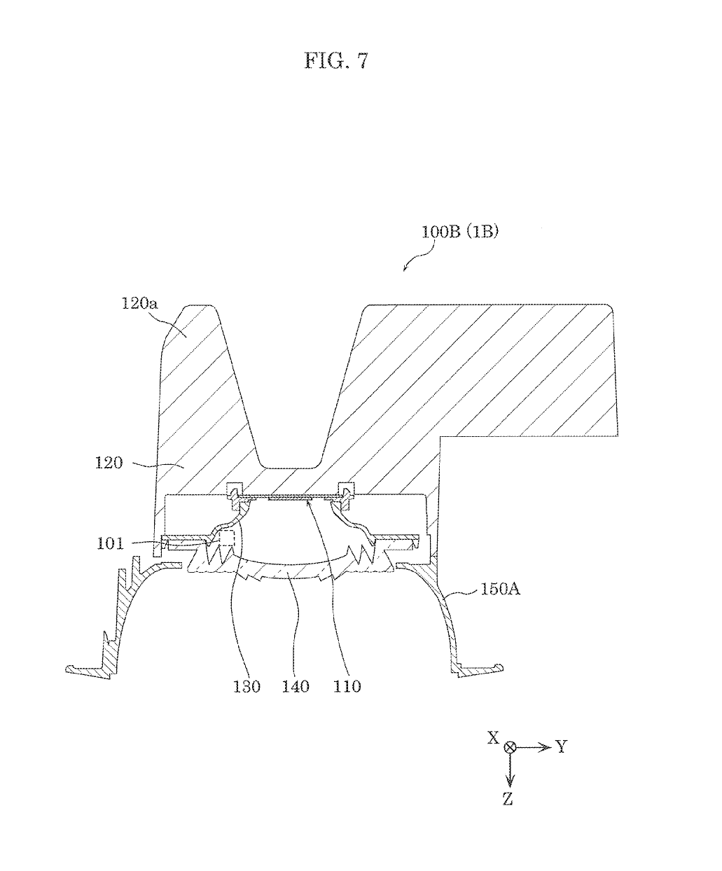

Next, lighting fixture 1B according to Variation 2 of Embodiment 1 will be described with reference to FIG. 7. FIG. 7 is a cross sectional view of lamp 100B included in lighting fixture 1B according to Variation 2 of Embodiment 1. Note that in FIG. 7, only a cross section of lamp 100B is illustrated.

In lighting fixture 1 according to Embodiment 1 described above, infrared communication receiver 101 is provided on frame 150 of lamp 100, but in lighting fixture 1B according to this variation, similar to lighting fixture 1A according to Variation 1 described above, infrared communication receiver 101 is disposed adjacent to light source 110 of lamp 100B.

Moreover, with lighting fixture 1A according to Variation 1 described above, infrared communication receiver 101 is disposed between reflector 130 and pedestal 120, but with lighting fixture 1B according to this variation, infrared communication receiver 101 is disposed between reflector 130 and lens 140.

Accordingly, with lighting fixture 1B according to this variation, similar to lighting fixture 1A according to Variation 1 described above, infrared communication receiver 101 is disposed adjacent to light source 110 of lamp 100B.

With this, the user can control a lighting aspect of the illumination light from lamp 100B by pointing infrared remote control 3 in the general direction of lamp 100B and transmitting an infrared signal.

Moreover, with lighting fixture 1B according to this variation, infrared communication receiver 101 is disposed between reflector 130 and lens 140.

With this, infrared signals reach infrared communication receiver 101 simply by passing through lens 140. Accordingly, compared to lighting fixture 1A according to Variation 1 described above, infrared signal sensitivity is improved.

### Embodiment 2

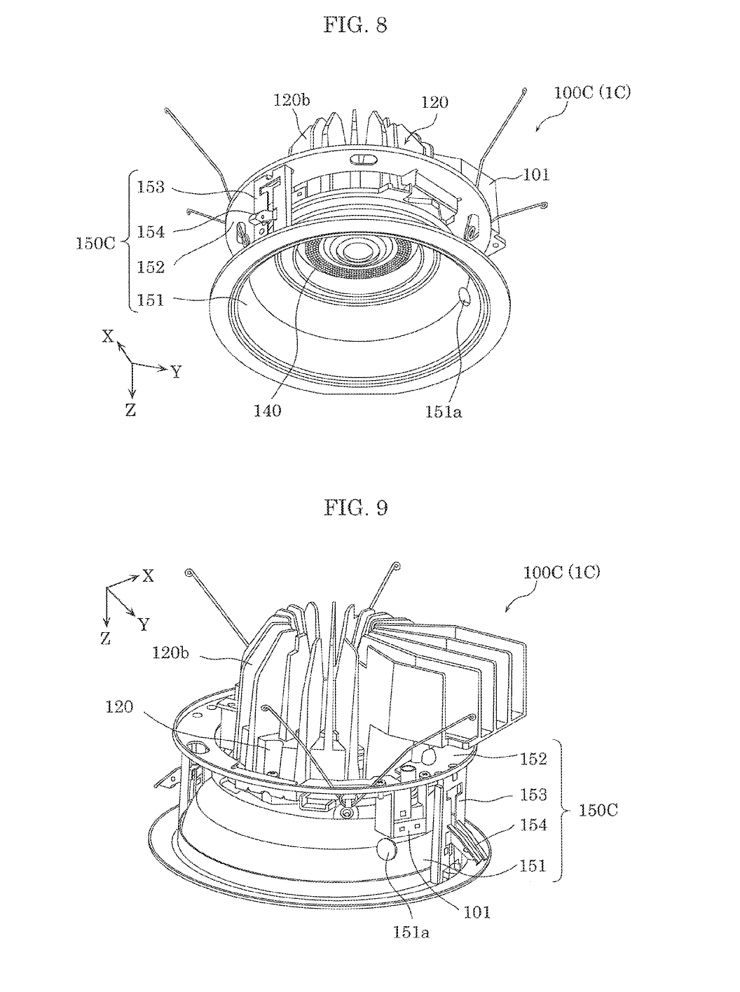

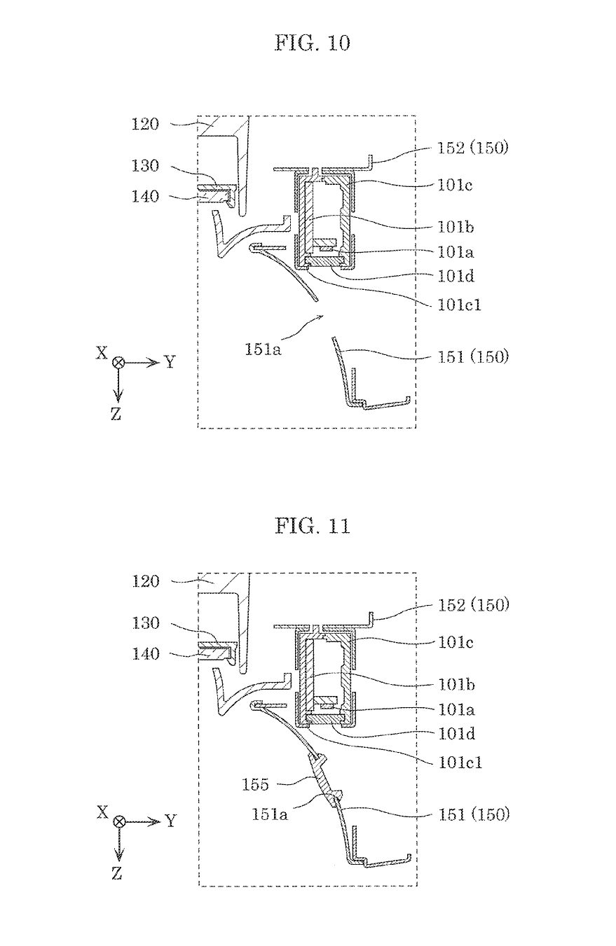

Next, lighting fixture 1C according to Embodiment 2 will be described with reference to FIG. 8 through FIG. 10. FIG. 8 is a perspective view of lamp 100C included in lighting fixture 1C according to Embodiment 2. FIG. 9 is a perspective view of the same lamp 100C. FIG. 10 is an enlarged view of part of the same lamp 100C. Note that in FIG. 8 and FIG. 9, illustration of first wire 310 and second wire 320 is omitted. Moreover, in FIG. 10, only a cross section of lamp 100C is illustrated.

The configuration of the frame in the lamp differs between lighting fixture 1C according to this embodiment and lighting fixture 1 according to Embodiment 1 described above.

Similar to Embodiment 1 described above, frame 150C in lamp 100C according to this embodiment is an attachment component for attaching lamp 100C to ceiling 2 when lamp 100c is in opening 2a in ceiling 2, and attaches to ceiling 2 in opening 2a, but frame 150C according to this embodiment is configured as a frame unit including auxiliary reflector 151 and frame plate 152.

Auxiliary reflector 151 is a cup-shaped frame. Auxiliary reflector 151 is made of a metal material such as aluminum. Moreover, through-hole 151a through which an infrared signal to be received by infrared communication receiver 101 passes is formed in auxiliary reflector 151. Through-hole 151a is disposed opposite the infrared receiver of infrared communication receiver 101. More specifically, through-hole 151a and the infrared receiver are aligned in a direction parallel to the optical axis of lamp 100.

Frame plate 152 is a ring-shaped frame component configured from a metal plate. Frame plate 152 is disposed so as to surround pedestal 120.

Auxiliary reflector 151 and frame plate 152 are coupled together by a pair of coupling components 153. Each coupling component 153 is provided with an attachment fitting 154 for attaching frame 150C to ceiling 2 in opening 2a. Frame 150C attaches to ceiling 2 in opening 2a as a result of attachment fitting 154 hooking onto the edge of ceiling 2 defined by opening 2a.

Note that frame 150C may be attached to ceiling 2 in opening 2a of ceiling 2 without using attachment fitting 154 by using frame plate 152 as a top panel and fixing frame plate 152 to ceiling 2 with bolts and nuts.

Just like in Embodiment 1 described above, in this embodiment as well, infrared communication receiver 101 is provided on frame 150C. More specifically, infrared communication receiver 101 is attached to frame plate 152 of frame 150C.

Accordingly, lighting fixture 1C according to this embodiment achieves the same advantageous effects as Embodiment 1 described above. Therefore, with lighting fixture 1C according to this embodiment, it is possible to perform both radio communication and infrared communication without having to change the size of opening 2a in ceiling 2.

Moreover, in lighting fixture 1C according to this embodiment, infrared communication receiver 101 is attached to frame plate 152, and through-hole 151a through which an infrared signal to be received by infrared communication receiver 101 passes is formed in auxiliary reflector 151.

This makes it possible to improve the reception sensitivity of the infrared signal by infrared communication receiver 101 and allow the user to easily recognize the location of infrared communication receiver 101 (infrared receiver 101a) via the location of through-hole 151a. Accordingly, the user can easily control a lighting aspect of the illumination light from lamp 100 by operating infrared remote control 3.

Moreover, as illustrated in FIG. 11, in lighting fixture 1C according to this embodiment, cap 155 is provided in through-hole 151a of auxiliary reflector 151 so as to plug through-hole 151a. Cap 155 is a light-transmissive cover and is formed of a material that transmits the infrared signals. In such a case, a transparent resin material or glass material may be used for cap 155, similar to lens 140.

In this way, by plugging through-hole 151a in auxiliary reflector 151 with cap 155 that transmits infrared signals, infrared signals can be received by infrared communication receiver 101 through through-hole 151a, foreign matter such as dust can be inhibited from entering through through-hole 151a, and light from light source 110 can be inhibited from leaking from through-hole 151a.

Note that cap 155 can also be used in lighting fixture 1 according to Embodiment 1.

Moreover, Variations 1 and 2 according to Embodiment 1 can also be applied to this embodiment. In other words, in this embodiment, infrared communication receiver 101 can be disposed in the vicinity of light source 110, as illustrated in FIG. 6 and FIG. 7.

### Embodiment 3

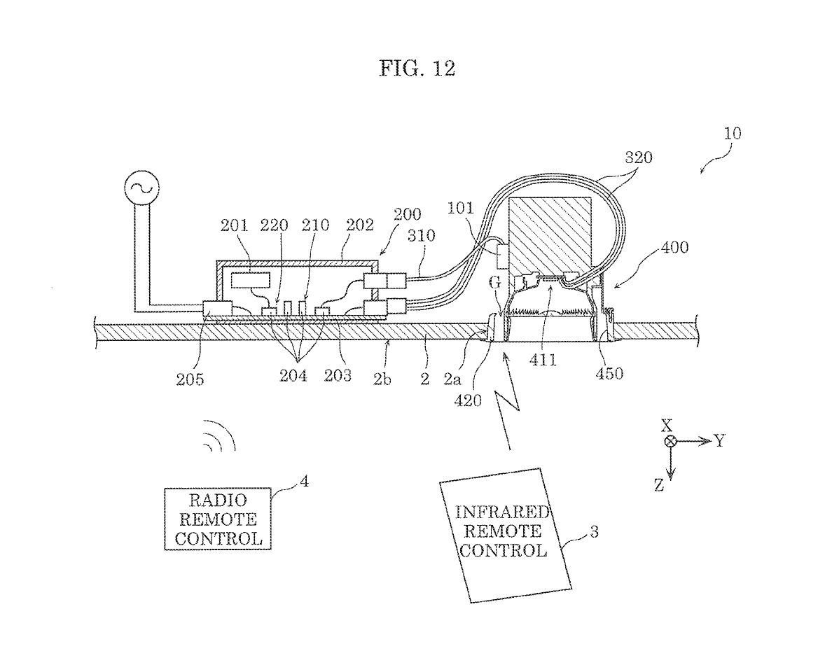

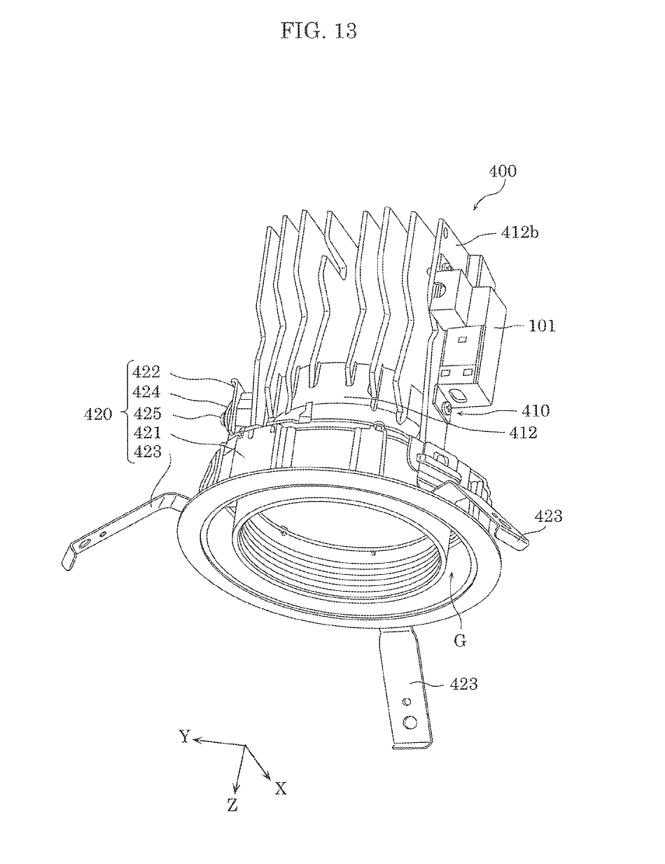

Next, an outline of the configuration of lighting fixture 10 according to Embodiment 3 will be given with reference to FIG. 12. FIG. 12 is a cross sectional view schematically illustrating lighting fixture 10 according to Embodiment 3, which is installed recessed in ceiling 2.

As illustrated in FIG. 12, similar to Embodiments 1 and 2 described above, lighting fixture 10 is a recessed ceiling lighting fixture, such as a downlight, and emits illumination light in a downward direction (toward, for example, the floor) as a result of being installed recessed in ceiling 2 of a building.

Lighting fixture 10 includes: lamp 400 including light source 411; and power supply 200 including power supply circuit 210. In this embodiment, lamp 400 and power supply 200 are structurally separate units, and are installed in different locations in ceiling 2.

More specifically, lamp 400 is installed recessed in opening 2a of ceiling 2. Similar to Embodiments 1 and 2 described above, power supply 200 is installed disposed on the rear surface of (i.e., behind) ceiling 2.

Lamp 400 is a lamp body that includes light source 411, and emits illumination light. Similar to Embodiments 1 and 2 described above, lamp 400 also includes infrared communication receiver 101 that receives an infrared signal (infrared light). Infrared communication receiver 101 has the same functions as described in above Embodiments 1 and 2. Note that infrared remote control 3 and radio remote control 4 also have the same functions as described in above Embodiments 1 and 2.

Power supply 200 has a power supply function of generating power for causing light source 411 to emit light. Power supply 200 has the same functions as described in above Embodiments 1 and 2. For example, via power supply circuit 210, power supply 200 converts AC power originating from a utility power source and supplied from power supply terminal block 205 into DC power.

Power supply 200 and lamp 400 (light source 411) are connected via second wire 320, and the DC power generated by power supply 200 is supplied to light source 411 of lamp 400 via second wire 320. Similar to Embodiments 1 and 2 described above, second wire 320 is a power supply wire, such as a power cable.

Similar to Embodiments 1 and 2 described above, in lighting fixture 10 configured in such a manner, for example, in response to an infrared signal (light) transmitted from infrared remote control 3 being received by infrared communication receiver 101, in accordance with the instruction in the infrared signal, lamp 400 (light source 411) is turned on or off, or the brightness, color, or color temperature of the light emitted by lamp 400 (light source 411) is changed.

### (Lamp)

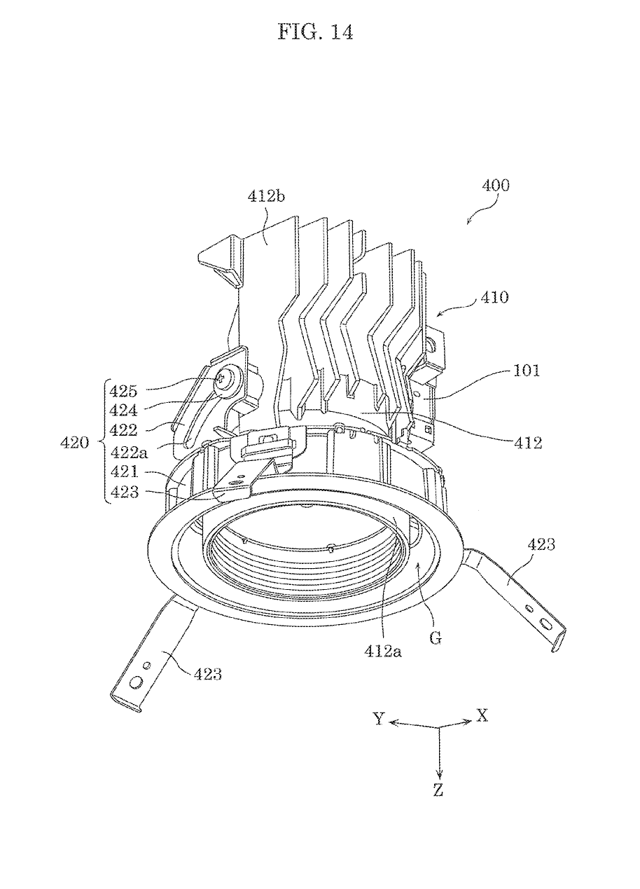

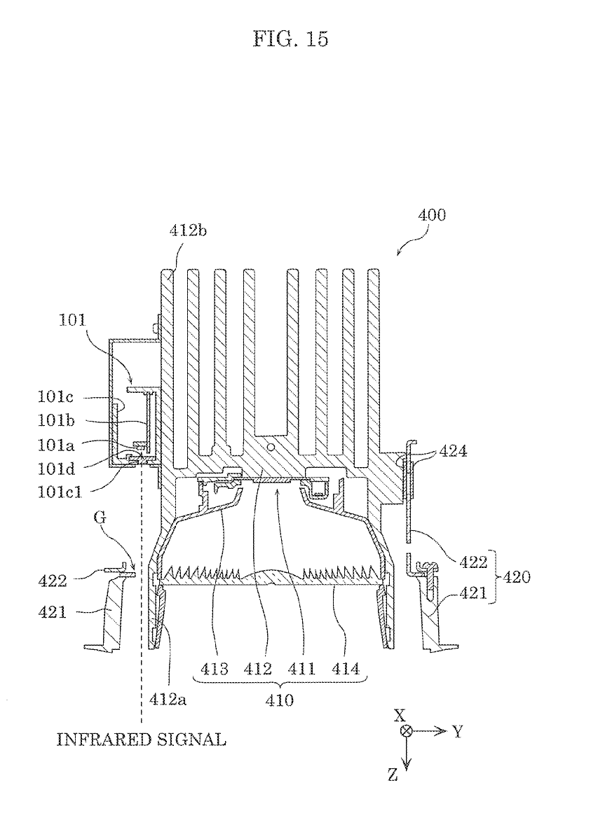

Next, the configuration of lamp 400 in lighting fixture 10 according to Embodiment 3 will be described in detail with reference to FIG. 13 through FIG. 15. FIG. 13 and FIG. 14 are perspective views of lamp 400 included in lighting fixture 10 according to Embodiment 3. FIG. 15 is a cross sectional view of the same lamp 400. Note that in FIG. 15, only a cross section of lamp 400 is illustrated. Moreover, in FIG. 13 through FIG. 15, illustration of first wire 310 and second wire 320 is omitted.

As illustrated in FIG. 13 through FIG. 15, lamp 400 includes: fixture main body 410 including light source 411 (see FIG. 15); and frame 420.

Lighting fixture 10 according to this embodiment is a universal type downlight, and lamp 400 is configured to change the orientation of fixture main body 410 (light source 411) relative to ceiling surface 2b of ceiling 2 so as to make the emission direction of illumination light from light source 411 changeable.

### (Fixture Main Body)

Fixture main body 410 is a lamp body that emits illumination light via light source 411. Fixture main body 410 is supported by frame 420. In this embodiment, fixture main body 410 rotates so as to change the angle between the optical axis of light source 411 and ceiling surface 2b of ceiling 2, and is supported by frame 420 so as to be horizontally rotatable relative to ceiling surface 2b.

In this embodiment, fixture main body 410 includes light source 411, pedestal 412, reflector 413, and lens 414.

### (Light Source)

Light source 411 illustrated in FIG. 15 is a light source module that emits, for example, white light as the illumination light. In this embodiment, light source 411 is an LED module (LED light source) including LEDs. In one example, light source 411 has a COB structure and includes a substrate, LEDs mounted on the substrate, and a sealant that seals the LEDs, similar to light source 110 described in Embodiments 1 and 2 above.

Light source 411 attaches to pedestal 412 via a holder, as illustrated in FIG. 15. In this embodiment as well, light source 411 is disposed centered about the optical axis lamp 400.

### (Pedestal)

Pedestal 412 is a fixture main body on which light source 411 is disposed. Pedestal 412 functions to support light source 411 and as a heat sink that disperses heat generated by light source 411. Accordingly, pedestal 412 is desirably made of a material having a high rate of heat transfer, such as a metal such as aluminum or a highly thermally conductive resin. In this embodiment, pedestal 412 is made of die cast aluminum.

As illustrated in FIG. 15, pedestal 412 has a recess including opening 412a. Light source 411, reflector 413, and lens 414 are disposed in the recess in substrate 412. Note that a frame-shaped baffle is disposed in opening 412a of pedestal 412.

Moreover, as illustrated in FIG. 13 through FIG. 15, a plurality of heat dissipating fins 412b are provided on pedestal 412. Each of the plurality of heat dissipating fins 412b has the shape of a flat plate and extends from a rear surface of the pedestal 410, in an area behind the recess of the fixture main body 410.

### (Reflector)

Reflector 413 illustrated in FIG. 15 is a reflective component that reflects light emitted by light source 411. More specifically, the inner surface of reflector 413 is a reflective surface that reflects light from light source 411. The reflective surface allows reflector 413 to direct the light emitted by light source 411 in a desired direction. In this embodiment, reflector 413 controls the distribution of light such that the light emitted by light source 411 is incident on lens 414. In one example, reflector 413 has the shape of a cylinder whose inner surface is funnel shaped, and whose inner diameter gradually increases from the opening on the side through which light enters (light source side) toward the opening on the side through which light exits.

For example, similar to reflector 130 according to Embodiments 1 and 2 described above, reflector 413 can be formed from a resin material or metal material.

Reflector 413 configured in this manner is attached to pedestal 412. More specifically, reflector 413 is indirectly attached to pedestal 412 by being attached to a holder fixed to pedestal 412 for holding light source 411 to pedestal 412.

### (Lens)

As illustrated in FIG. 13 and FIG. 15, lens 414 is arranged so as to cover light source 411. More specifically, lens 414 is attached in the opening of pedestal 412 so as to cover the opening of reflector 413.

Lens 414 transmits light from light source 411 and light reflected by reflector 413. More specifically, lens 414 has a function of controlling, in a predetermined direction, the distribution of light from light source 411 and light reflected by reflector 413. In this embodiment, lens 414 has a Fresnel structure having the function of a Fresnel lens. Lens 414 may have a light diffusing structure, similar to lens 140 according to Embodiments 1 and 2 described above.

Lens 414 is formed from a light-transmissive material having light transmitting properties. More specifically, lens 414 is made of a transparent resin material such as acrylic or polycarbonate, or a glass material.

### [Frame]

As illustrated in FIG. 12, frame 420 is an attachment component for attaching lamp 400 to ceiling 2 while in opening 2a of ceiling 2. More specifically, frame 420 is attached to ceiling 2 in opening 2a so as to hold fixture main body 410 in opening 2a of ceiling 2.

As illustrated in FIG. 14 and FIG. 15, frame 420 is configured as a frame component including frame body 421, support arm 422, and attachment springs 423.

In this embodiment, frame body 421 is a cup-shaped approximate cylinder having a first opening on the vertical lower side and a second opening on the vertical upper side. Frame body 421 is made of, for example, a metal material such as aluminum. In this embodiment, frame body 421 is made of die cast aluminum. Note that the material used for frame body 421 is not limited to a metal material, and may be a resin material.

A flange-shaped brim is formed around the first opening on the vertical lower side of frame body 421. Lamp 400 is held in opening 2a by abutting the brim of frame body 421 to ceiling surface 2b of ceiling 2 and three attachment springs 423 provided on the outer surface of frame body 421 pressing against the inner side surface of ceiling 2 defined by opening 2a. Attachment springs 423 are elastic components for attaching lamp 400 to ceiling 2 while in opening 2a of ceiling 2, and have a leaf spring structure. For example, each attachment spring 423 is formed from an elongated metal plate.

Support arm 422 is a support plate embodied as a metal plate, and couples frame 420 and fixture main body 410 together. In this embodiment, support arm 422 couples frame body 421 of frame 420 and pedestal 412 of fixture main body 410 together.

Slit 422a for rotatably changing the orientation of fixture main body 410 relative to ceiling surface 2b is provided in support arm 422. Accordingly, slit 422a has a constant width (slit width) along the direction of rotation of fixture main body 410.

Support arm 422 is held in place by pedestal 412 and ring components 424 via slit 422a. More specifically, as a result of a pair of ring components 424 larger in diameter than the width of slit 422a sandwiching support arm 422, and screw 425 being inserted through through-holes formed in ring components 424 and screwed into pedestal 412, support arm 422 is held in place by pedestal 412 and ring components 424 via the clamping force from screw 425.

With this configuration, by rotating pedestal 412, screw 425 screwed into pedestal 412 moves along slit 422a. With this, since fixture main body 410 can rotate along the shape of slit 422a, it possible to change the orientation of fixture main body 410 relative to ceiling surface 2b.

Note that rotated fixture main body 410 can be held at a given angle by the clamping force of pedestal 412 and ring component 424 holding support arm 422. In such a case, it is possible to adjust the clamping force of pedestal 412 and ring component 424 holding support arm 422 by adjusting the torque of screw 425.

Moreover, support arm 422 is configured so as to be rotatable with respect to frame 420 in a plane parallel to ceiling surface 2b. More specifically, the end area of support arm 422 on the frame 420 side is fixed to frame body 421 so as to slide on an end surface of frame body 421 defined by the opening on the ceiling 2 side. This makes it possible to horizontally rotate fixture main body 410 in a plane parallel to ceiling surface 2b.

Frame 420 configured in this manner surrounds a part of fixture main body 410 and is spaced apart from fixture main body 410 by gap G. In other words, gap G is provided circumferentially between frame 420 and fixture main body 410. In this embodiment, frame body 421 of frame 420 is disposed so as to surround opening 412a of pedestal 412 of fixture main body 410, and gap G is provided between the inner surface of frame body 421 and the outer surface of the side wall of pedestal 412 defined by opening 412a.

### (Infrared Communication Receiver)

Infrared communication receiver 101 is provided on lamp 400, and has a function of receiving infrared signals. More specifically, infrared communication receiver 101 converts received infrared signals into predetermined control signals (electrical signals). Similar to Embodiments 1 and 2 described above, infrared communication receiver 101 according to this embodiment is a compact module since it only has the function of infrared communication.

As illustrated in FIG. 15, infrared communication receiver 101 is provided on fixture main body 410. In this embodiment, infrared communication receiver 101 is attached to the side surface of pedestal 412 of fixture main body 410. More specifically, infrared communication receiver 101 is attached to the side surface of heat dissipating fins 412b of pedestal 412. Accordingly, infrared communication receiver 101 rotates in conjunction with rotation of fixture main body 410 (pedestal 412).

Moreover, infrared communication receiver 101 provided on lamp 400 is provided on fixture main body 410 so as to be capable of receiving infrared signals via gap G between frame 420 and fixture main body 410 (pedestal 412). In other words, gap G is an infrared signal opening for passing infrared signals.

Through-hole 101c1 for infrared signals to pass through is formed in case 101c of infrared communication receiver 101, similar to Embodiments 1 and 2 described above. Through-hole 101c1 in infrared communication receiver 101 is aligned with gap G between frame 420 and fixture main body 410, as illustrated in FIG. 15. With this, infrared receiver 101a is aligned with gap G between frame 420 and fixture main body 410 with through-hole 101c1 in case 101c therebetween. Accordingly, infrared signals transmitted from infrared remote control 3 reach infrared receiver 101a after passing through gap G between frame 420 and fixture main body 410.

### (Rotational Movement of Lamp)

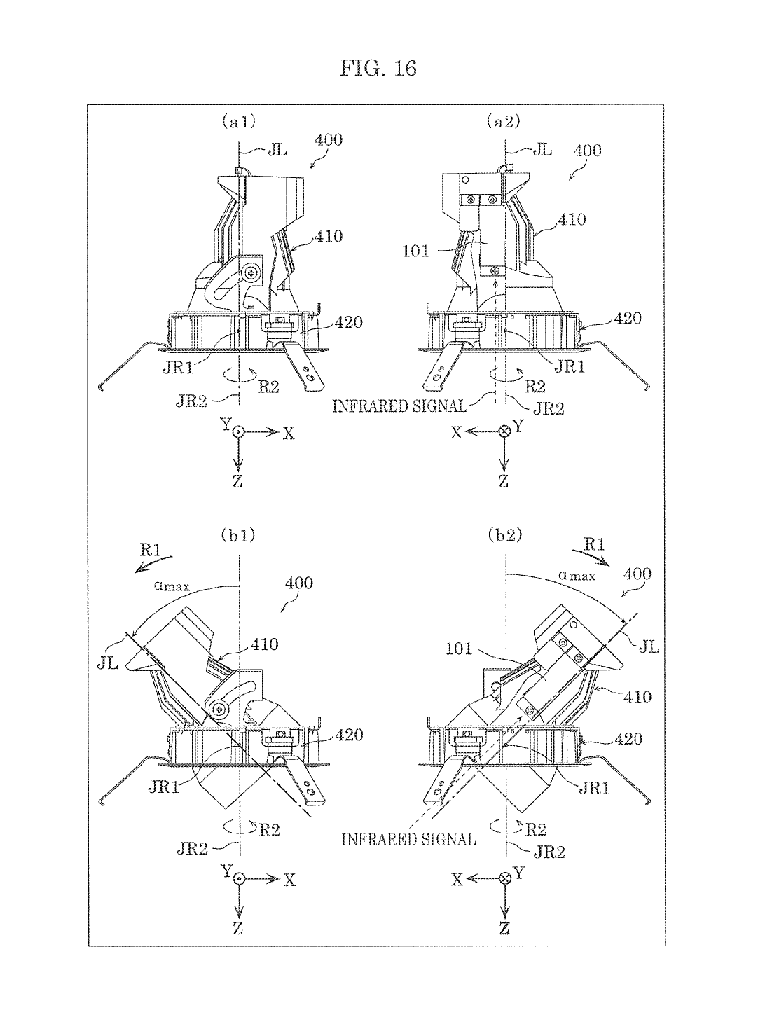

Next, the rotational movement of lamp 400 in lighting fixture 10 according to Embodiment 3 will be described with reference to FIG. 16. FIG. 16 is for illustrating the rotational movement of lamp 400 included in lighting fixture 10 according to Embodiment 3.

In FIG. 16, (a1) and (a2) illustrate fixture main body 410 in unrotated states where optical axis JL of fixture main body 410 (light source 411) is parallel to the Z axis, and (b1) and (b2) illustrate fixture main body 410 rotated to maximum angles.

With lamp 400 according to this embodiment, fixture main body 410 is rotatably held by frame 420 (held so as to be capable of oscillating). More specifically, fixture main body 410 is rotatably held by frame 420 such that the orientation of fixture main body 410 relative to ceiling surface 2b is changeable. In this way, the light emission direction of lamp 400 (light source 411) is changeable by changing the orientation of fixture main body 410 relative to ceiling surface 2b.

In this embodiment, fixture main body 410 is swingably rotatable in direction of rotation R1, where an axis parallel to the Y axis is defined as rotational axis JR1 (swing axis). Here, as illustrated in (b1) and (b2) in FIG. 16, the maximum rotational angle α_{MAX} to which fixture main body 410 can rotate (swing) is, in one example, 45 degrees, but this example is not limiting.

With lamp 400, it is possible to hold fixture main body 410 at a desired angle (oscillation angle) within a range delimited by the maximum rotational angle α_{MAX}, and the light emission direction can be freely changed by changing the oscillation angle of fixture main body 410.

Further, in addition to the orientation of fixture main body 410 relative to ceiling surface 2b, fixture main body 410 is also freely rotatable about a direction of rotation R2, where rotational axis JR2 is defined as being parallel to a direction perpendicular to ceiling surface 2b (in this embodiment, parallel to the Z axis). In other words, fixture main body 410 can rotate horizontally in a plane parallel to ceiling surface 2b. This makes it possible to horizontally rotate fixture main body 410 in a state in which fixture main body 410 is tilted at an angle relative to ceiling surface 2b.

In this embodiment, fixture main body 410 is rotatable in direction of rotation R2, where the central axis of frame 420 is defined as rotational axis JR2. The maximum rotational angle to which fixture main body 410 can rotate in direction of rotation R2 is, in one example, approximately 355 degrees, but this example is not limiting.

In this way, fixture main body 410 is freely rotatable about two axes: rotational axis JR1 and rotational axis JR2, whereby the direction of travel of light from fixture main body 410 (light source 411) can be changed by rotating fixture main body 410.

Moreover, in this embodiment, since infrared communication receiver 101 is attached to fixture main body 410, it is possible to change the orientation of infrared communication receiver 101 in conjunction with the rotation of fixture main body 410 by rotating fixture main body 410. This makes it possible to change the range in which it is possible for infrared communication receiver 101 to receive signals (i.e., change the detection region).

### (Working Effects)

Next, the working effects of lighting fixture 10 according to this embodiment will be described.

In lighting fixture 10 according to the present embodiment, radio communication circuit 201 is included in power supply 200 disposed behind the ceiling, and infrared communication receiver 101 is included in lamp 400 installed recessed in opening 2a of ceiling 2, as illustrated in FIG. 12. In other words, infrared communication receiver 101 and radio communication circuit 201 are separated, and infrared communication receiver 101 is included in lamp 400, which is visible to the user.

By including infrared communication receiver 101 in lamp 400 installed recessed in opening 2a of ceiling 2 in this way, the user can easily perform infrared communication with lighting fixture 10.

More specifically, when the user wants to control a lighting aspect of the illumination light emitted by lamp 400 (light source 411), the user can control a lighting aspect of lamp 400 (light source 411) by pointing infrared remote control 3 toward lamp 400 and operating infrared remote control 3 so as to transmit an infrared signal. For example, the user can turn on or off lamp 400 (light source 411) or change the brightness, color, and/or color temperature of the illumination light.

Moreover, since power supply 200 includes radio communication circuit 201, the user can easily perform radio communication with lighting fixture 10. More specifically, when the user wants to change the settings in lighting fixture 10 or wants to control a lighting aspect of the illumination light emitted by lamp 400 (light source 411), the user can change the settings in lighting fixture 10 or control a lighting aspect of lamp 400 (light source 411) by operating radio remote control 4 so as to transmit a radio signal.

Additionally, since radio communication circuit 201 is included in power supply 200 rather than lamp 400, it is possible to inhibit an increase in the size of lamp 400 and it is not necessary to increase the size of opening 2a in ceiling 2.

With lighting fixture 10 according to this embodiment, it is possible to perform both radio communication and infrared communication even when lighting fixture 10 is embodied as a recessed ceiling lighting fixture.

Moreover, with lighting fixture 10 according to this embodiment, lamp 400 is configured to change the orientation of light source 411 relative to ceiling surface 2b of ceiling 2. More specifically, as illustrated in FIG. 16, fixture main body 410 can freely rotate about two axes, whereby the light emission direction of lamp 400 can be changed by rotating fixture main body 410.

This makes it possible to change the range in which it is possible for infrared communication receiver 101 to receive signals (i.e., change the detection region) by rotating fixture main body 410 since infrared communication receiver 101 is included in lamp 400.

Moreover, with lighting fixture 10 according to this embodiment, since infrared communication receiver 101 and radio communication circuit 201 are disposed separate from each other, compared to a configuration in which the radio communication unit and the infrared communication unit are integrated in a communication module, it is possible to reduce the size of each module.

With this, infrared communication receiver 101 and radio communication circuit 201 can be installed without having to increase the diameter of opening 2a of ceiling 2.

In particular, with lighting fixture 10 according to this embodiment, infrared communication receiver 101 is included in lamp 400, which is visible to the user, but infrared communication receiver 101 is a compact module having only an infrared communication function. With this, since infrared communication receiver 101 is included in lamp 400, it is possible to avoid a negative impact on the design aesthetics of lamp 400.

Moreover, similar to Embodiments 1 and 2 described above, lighting fixture 10 according to this embodiment also further includes first wire 310 that transmits, to power supply 200, a control signal dependent on the infrared signal received by infrared communication receiver 101.

This makes it possible to control a lighting aspect of the illumination light emitted by lamp 400 (light source 411) by processing, via power supply 200, a control signal dependent on the infrared signal received by infrared communication receiver 101. This makes it possible to inhibit an increase in costs since it eliminates a need to mount, for example, another power supply circuit or control circuit in lamp 400.

Moreover, as illustrated in FIG. 12, with lighting fixture 10 according to this embodiment, frame 420 attached to ceiling 2 while in opening 2 of ceiling 2 surrounds a part of fixture main body 410 and is spaced apart from fixture main body 410 by gap G. Moreover, infrared communication receiver 101 is provided on fixture main body 410 in a manner that allows for reception of infrared signals through gap G. More specifically, as illustrated in FIG. 15, infrared communication receiver 101 is provided on pedestal 412 of fixture main body 410.

This configuration makes it possible to receive infrared signals through gap G provided between frame 420 and fixture main body 410. Accordingly, it is not necessary to change the shape of fixture main body 410 (pedestal 412) or frame 420 in order to have enough space to accommodate infrared communication receiver 101. Accordingly, it is possible to avoid a negative impact on the design aesthetics due to the provision of infrared communication receiver 101 and it is possible to use an existing fixture main body 410 or frame 420, which in turn makes it possible to achieve a low cost lighting fixture capable of both radio communication and infrared communication.

### Variation 1 of Embodiment 3

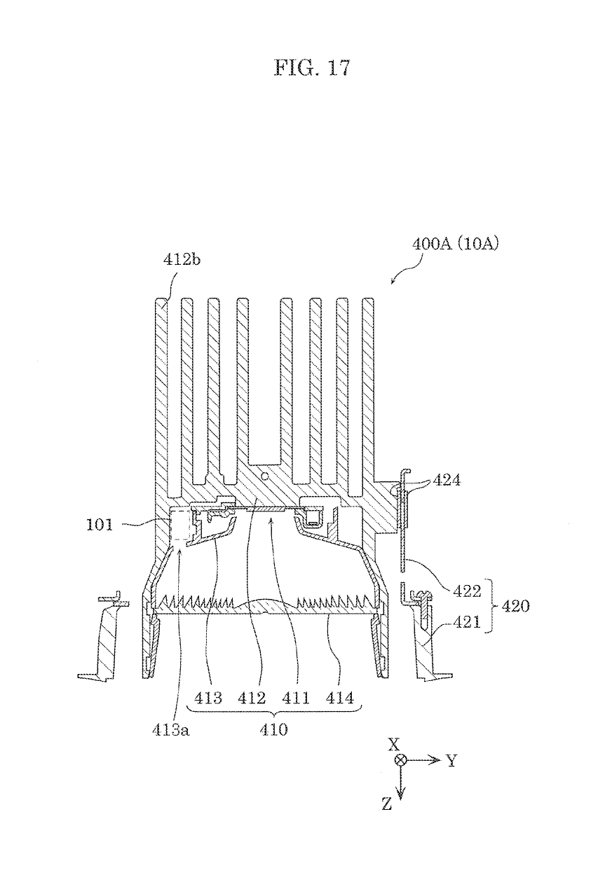

Next, lighting fixture 10A according to Variation 1 of Embodiment 3 will be described with reference to FIG. 17. FIG. 17 is a cross sectional view of lamp 400A included in lighting fixture 10A according to Variation 1 of Embodiment 3.

In lighting fixture 10 according to Embodiment 3 described above, infrared communication receiver 101 is provided on the side surface of pedestal 412 of lamp 400, but in lighting fixture 10A according to this variation, infrared communication receiver 101 is disposed adjacent to light source 411 of lamp 400A.

More specifically, in this variation, infrared communication receiver 101 is disposed between reflector 413 and pedestal 412. Moreover, through-hole 413a through which an infrared signal to be received by infrared communication receiver 101 passes is formed in reflector 413. Note that similar to Embodiment 3 described above, since lens 414 is made of a transparent resin material or glass material, infrared signals can pass through lens 414. With this, infrared signals can reach infrared receiver 101a (not illustrated in the figure) of infrared communication receiver 101 through lens 414 and through-hole 413a.

Note that in this variation, apart from the location of infrared communication receiver 101, the configuration of lighting fixture 10A is the same as lighting fixture 10 according to Embodiment 3 described above, including power supply 200.

Accordingly, with lighting fixture 10A according to this variation, infrared communication receiver 101 is disposed adjacent to light source 411 of lamp 400A.

Since light source 411 is disposed centered about the optical axis of lamp 400, by disposing infrared communication receiver 101 adjacent to light source 411, infrared communication receiver 101 is also disposed adjacent to the optical axis center of lamp 400. This makes it easier for infrared communication receiver 101 to receive infrared signals. In other words, even if the user does not know where infrared communication receiver 101 (infrared receiver 101a) is disposed or even without the user needing to figure out where infrared communication receiver 101 (infrared receiver 101a) is disposed, it is possible for the user to control a lighting aspect of the illumination light from lamp 400A simply by pointing infrared remote control 3 in the general direction of lamp 400A to transmit an infrared signal.

Moreover, with lighting fixture 10A according to this variation, infrared communication receiver 101 is disposed between reflector 413 and pedestal 412.

With this, since case 101c of infrared communication receiver 101 can be concealed, it is possible to avoid a negative impact on the design aesthetics of lamp 400A by infrared communication receiver 101.

Note that a cap is provided in through-hole 413a of reflector 413 so as to plug through-hole 413a. This cap is a light-transmissive cover and is formed of a material that transmits the infrared signals. In such a case, a transparent resin material or glass material may be used for the cap, similar to lens 414. In this way, by plugging through-hole 413a in reflector 413 with a cap that transmits infrared signals, infrared signals can be received by infrared communication receiver 101 through through-hole 413a, foreign matter such as dust can be inhibited from entering through through-hole 413a, and light from light source 411 can be inhibited from leaking from through-hole 413a.

### Variation 2 of Embodiment 3

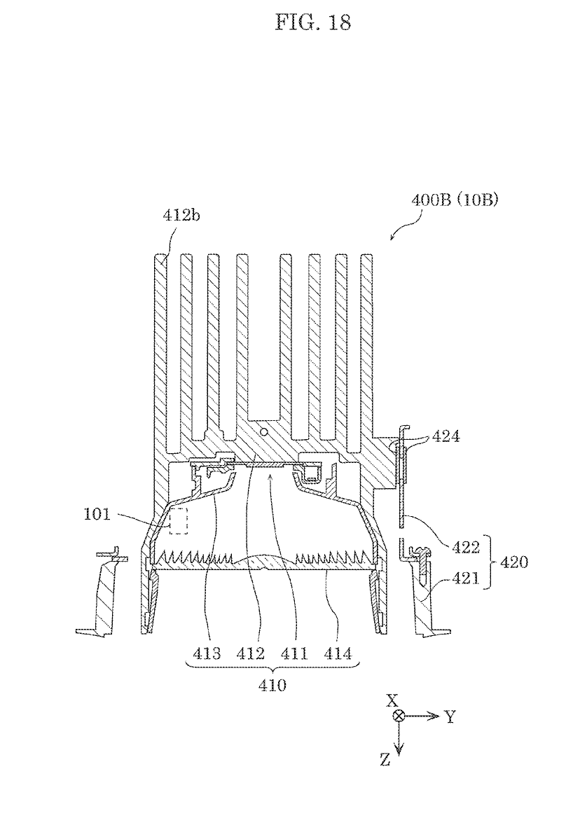

Next, lighting fixture 10B according to Variation 2 of Embodiment 3 will be described with reference to FIG. 18. FIG. 18 is a cross sectional view of lamp 400B included in lighting fixture 10B according to Variation 2 of Embodiment 3.

In lighting fixture 10 according to Embodiment 3 described above, infrared communication receiver 101 is provided on the side surface of pedestal 412 of lamp 400, but in lighting fixture 10B according to this variation, similar to lighting fixture 10A according to Variation 1 described above, infrared communication receiver 101 is disposed adjacent to light source 411 of lamp 400B.

Moreover, with lighting fixture 10A according to Variation 1 described above, infrared communication receiver 101 is disposed between reflector 413 and pedestal 412, but with lighting fixture 10B according to this variation, infrared communication receiver 101 is disposed between reflector 413 and lens 414.

Accordingly, with lighting fixture 10B according to this variation, similar to lighting fixture 10A according to Variation 1 described above, infrared communication receiver 101 is disposed adjacent to light source 411 of lamp 400B.

With this, the user can control a lighting aspect of the illumination light from lamp 400B by pointing infrared remote control 3 in the general direction of lamp 400B and transmitting an infrared signal.

Moreover, with lighting fixture 10B according to this variation, infrared communication receiver 101 is disposed between reflector 413 and lens 414.

With this, infrared signals reach infrared communication receiver 101 simply by passing through lens 414. Accordingly, compared to lighting fixture 10A according to Variation 1 described above, infrared signal sensitivity is improved.

### Variation 3 of Embodiment 3

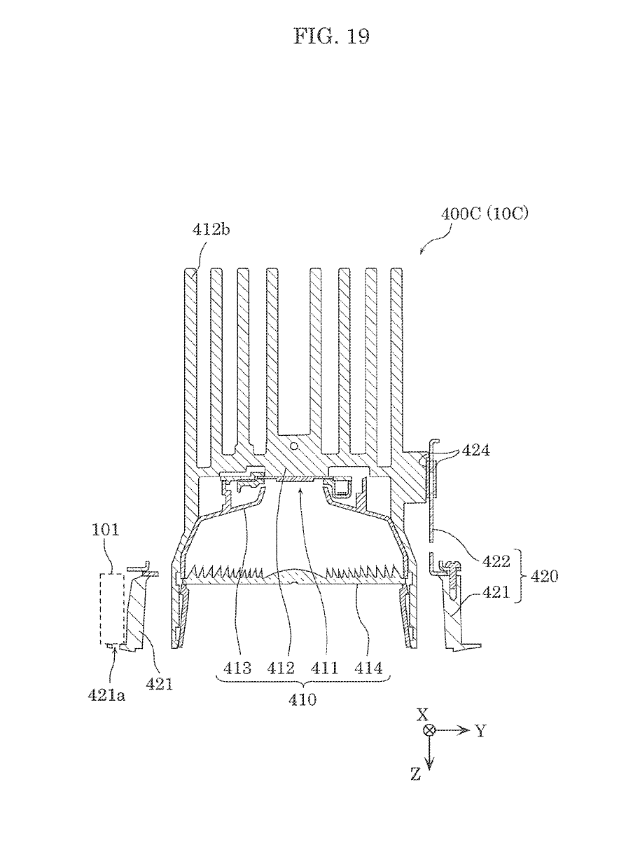

Next, lighting fixture 10C according to Variation 3 of Embodiment 3 will be described with reference to FIG. 19. FIG. 19 is a cross sectional view of lamp 400C included in lighting fixture 10C according to Variation 3 of Embodiment 3.

In lighting fixture 10 according to Embodiment 3 described above, infrared communication receiver 101 is provided on fixture main body 410 of lamp 400, but in lighting fixture 10C according to this variation, infrared communication receiver 101 is disposed on frame 420 of lamp 400C. More specifically, infrared communication receiver 101 is attached to the outer surface of frame body 421.

This configuration makes it possible to dispose infrared communication receiver 101 in a location in which infrared receiver 101a of infrared communication receiver 101 is visible and in which visibility of case 101c of infrared communication receiver 101 is concealed to the user behind frame 420. With this, by including infrared communication receiver 101, it is possible to avoid a negative impact on design aesthetics and easily perform infrared communication with lighting fixture 10. In other words, the user can easily control a lighting aspect of the illumination light from lamp 400 by pointing infrared remote control 3 toward infrared receiver 101a and transmitting an infrared signal.

Moreover, through-hole 421a through which an infrared signal to be received by infrared communication receiver 101 passes is formed in frame body 421. Through-hole 421a is a small diameter hold for receiving infrared signals. In this variation, through-hole 421a is provided in the brim of frame body 421. In other words, through-hole 421a is provided in location that is visible to the user.

This configuration makes it possible to improve the reception sensitivity of the infrared signal by infrared communication receiver 101 and allow the user to easily recognize the location of infrared communication receiver 101 (infrared receiver 101a) via the location of through-hole 421a. With this, the user can easily perform infrared communication with lighting fixture 10 by pointing the infrared transmitter of infrared remote control 3 toward the vicinity of through-hole 421a.

Note that as in Variation 2 described above, through-hole 421a may be plugged with a cap that transmits infrared signals.

### Other Variations

Hereinbefore, a lighting fixture according to the present disclosure has been described based on exemplary embodiments, but the present disclosure is not limited to the above embodiments.

For example, in the above embodiments, a single infrared communication receiver 101 is provided in lamp 100, but this example is not limiting. A plurality of infrared communication receivers 101 may be provided in lamp 100.

Moreover, in the above embodiments, a filter that blocks infrared light components included in light emitted by light source 110, 411 may be disposed in the vicinity of light source 110, 411. For example, when infrared communication receiver 101 is provided on frame 150, a filter that blocks infrared light components may be fitted to lens 140, 414. A component including a filter that blocks infrared light components may also be attached in front or behind lens 140, 414. Moreover, instead of a filter that blocks infrared light components, a material that absorbs infrared light components may be included in lens 140, 414. In this way, by filtering out the infrared light components included in the light emitted by light source 110, 411, unwanted infrared light can be inhibited from reaching infrared communication receiver 101, thereby inhibiting erroneous detection by infrared communication receiver 101.

Moreover, in the above embodiments, light source 110, 411 is configured to emit white light via usage of blue LEDs and yellow phosphor, but this example is not limiting. For example, a configuration in which blue LEDs are paired with a phosphor-containing resin containing red and green phosphor may be used to produce white light.

Moreover, in the above embodiments, the LEDs are exemplified as blue LEDs, but this example is not limiting. For example, the LEDs may be those that emit light of a color other than blue light, or those that emit ultraviolet light. In such a case, the phosphor to be used may be selected in accordance with the wavelength of the light emitted by the LEDs.

Moreover, in the above embodiments, light source 110, 411 is exemplified as having a COB structure in which LED chips are directly mounted on a mounting substrate, but this example is not limiting. For example, instead of a LED module having a COB structure, a LED module having a surface mount device (SMD) structure may be used. An SMD LED module has a configuration in which one or more package LED elements (SMD LED elements) including a resin package (container) having a cavity, an LED chip (light-emitting element) mounted in the cavity, and a sealant (phosphor-containing resin) filling the cavity are mounted on a mounting substrate.

Moreover, in the above embodiments, LEDs are exemplified as the sources of light used in light source 110, 411, but this example is not limiting. For example, the source of light used in light source 110, 411 may be a semiconductor light-emitting element such as a semiconductor laser, a solid state light-emitting element other than an LED such as an organic or inorganic electroluminescent (EL) element, or an existing lamp such as a fluorescent lamp or a high-luminance lamp.

Note that in Embodiment 3 described above, fixture main body 410 is configured so as to freely rotate about two axes by using support arm 422, but this example is not limiting. Fixture main body 410 may freely rotate about two axes using some other configuration.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A lighting fixture, comprising:
a lamp that is configured to be recessed in an opening of a ceiling, and includes a light source that emits illumination light; and
a power supply that is configured to be disposed behind the ceiling when the lighting fixture is in the opening of the ceiling, and to generate power for causing the light source to emit the illumination light,
wherein the lamp includes an infrared communication receiver that receives an infrared signal for controlling the lighting fixture, and
the power supply includes a radio communication circuit that receives a radio signal for controlling the lighting fixture.

2. The lighting fixture according to claim 1, further comprising:
a wire that transmits, to the power supply, a control signal dependent on the infrared signal received by the infrared communication receiver.

3. The lighting fixture according to claim 1, wherein
the lamp includes a pedestal on which the light source is disposed, and a frame that is fixed to the pedestal and configured to attach to the ceiling when the lighting fixture is in the opening of the ceiling, and
the infrared communication receiver is provided on the frame.

4. The lighting fixture according to claim 3, wherein
the frame includes a through-hole through which the infrared signal received by the infrared communication receiver passes.

5. The lighting fixture according to claim 4, wherein
the frame includes an auxiliary reflector, and
the through-hole is provided in the auxiliary reflector.

6. The lighting fixture according to claim 4, further comprising:
a cap that plugs the through-hole,
wherein the cap includes a material that transmits the infrared signal.

7. The lighting fixture according to claim 1, wherein
the infrared communication receiver is disposed adjacent to the light source.

8. The lighting fixture according to claim 7, wherein
the lamp includes a pedestal on which the light source is disposed, and a reflector that is attached to the pedestal and reflects the illumination light emitted by the light source,
the infrared communication receiver is disposed between the reflector and the pedestal, and
the reflector includes a through-hole through which the infrared signal received by the infrared communication receiver passes.

9. The lighting fixture according to claim 7, wherein
the lamp includes a pedestal on which the light source is disposed, a reflector that is attached to the pedestal and reflects the illumination light emitted by the light source, and a lens that transmits the illumination light reflected by the reflector, and
the infrared communication receiver is disposed between the reflector and the lens.

10. The lighting fixture according to claim 1, wherein
the lamp is configured to change an orientation of the light source relative to a surface of the ceiling.

11. The lighting fixture according to claim 10, further comprising:
a wire that transmits, to the power supply, a control signal dependent on the infrared signal received by the infrared communication receiver.

12. The lighting fixture according to claim 10, wherein
the lamp includes a fixture main body including the light source and a frame configured to attach to the ceiling when the lighting fixture is in the opening of the ceiling,
the frame surrounds a part of the fixture main body and defines a gap between the fixture main body and the frame, and
the infrared communication receiver is provided on the fixture main body and receives the infrared signal through the gap.

13. The lighting fixture according to claim 12, wherein
the fixture main body includes a pedestal on which the light source is disposed, and
the infrared communication receiver is provided on a side surface of the pedestal.

14. The lighting fixture according to claim 10, wherein
the infrared communication receiver is disposed adjacent to the light source.

15. The lighting fixture according to claim 14, wherein
the fixture main body includes a pedestal on which the light source is disposed, and a reflector that is attached to the pedestal and reflects the illumination light emitted by the light source,
the infrared communication receiver is disposed between the reflector and the pedestal, and
the reflector includes a through-hole through which the infrared signal received by the infrared communication receiver passes.

16. The lighting fixture according to claim 14, wherein
the fixture main body includes a pedestal on which the light source is disposed, a reflector that is attached to the pedestal and reflects the illumination light emitted by the light source, and a lens that transmits the illumination light reflected by the reflector, and
the infrared communication receiver is disposed between the reflector and the lens.

17. The lighting fixture according to claim 10, wherein
the lamp includes a fixture main body including the light source and a frame configured to attach to the ceiling when the lighting fixture is in the opening of the ceiling,
the frame surrounds a part of the fixture main body and defines a gap between the fixture main body and the frame,
the infrared communication receiver is provided on the frame, and
the frame includes a through-hole through which the infrared signal received by the infrared communication receiver passes.

18. The lighting fixture according to claim 1, wherein
the infrared communication receiver receives the infrared signal for controlling a lighting aspect of the illumination light.
